(19) United States
(12) Patent Application Publication
(10) Pub. No.: US 2019/0081705 A1
(43) Pub. Date: Mar. 14, 2019

(54) MULTIMODE WAVEGUIDE

(71) Applicant: Intel Corporation, Santa Clara, CA (US)

(72) Inventors: Henning Braunisch, Phoenix, AZ (US); Adel A. Elsherbini, Chandler, AZ (US); Georgios Dogiamis, Chandler, AZ (US); Telesphor Kamgaing, Chandler, AZ (US); Aleksandar Aleksov, Chandler, AZ (US); Johanna M. Swan, Scottsdale, AZ (US)

(73) Assignee: Intel Corporation, Santa Clara, CA (US)

(21) Appl. No.: 16/179,215

(22) Filed: Nov. 2, 2018

(51) Int. Cl. H04B 10/2581; G02B 6/43; H04B 10/50

(52) U.S. Cl. CPC H04B 10/2581; H04B 10/50; G02B 6/43

(57) ABSTRACT

There is disclosed in one example a communication apparatus, including: a local data interface; a data encoder to encode a transmission into n millimeter to terahertz-band transmission components, wherein n≥2, each transmission component having an independent mode of each other transmission component; and a plurality of n launchers to launch the transmission components onto n closely-bundled waveguides, wherein the closely-bundled waveguides are not shielded from one another.

### FIELD OF THE SPECIFICATION

This disclosure relates in general to the field of millimeter wave communication, and more particularly, though not exclusively, to a system for providing a multimode waveguide.

### BACKGROUND

Interconnects provide communication between computing elements in a computing system.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a perspective view of a waveguide connector.

FIG. 2 is a perspective view of selected elements of a waveguide.

FIG. 3 is a cutaway front view of a waveguide.

FIG. 4 is a cutaway front view of a waveguide providing bundled, unshielded dielectric waveguides.

FIG. 5 is a block diagram of a waveguide, including a first waveguide conduit and a second waveguide conduit.

FIG. 6 is a block diagram of a passive transmitter pair and a passive receiver pair.

FIG. 7 is a graph illustrating the transmission characteristics of a transmitter and receiver pair.

FIG. 8 illustrates an example of a waveguide in which two inner waveguides are provided.

FIG. 9 is a block diagram of a transmitter and receiver pair.

FIG. 10 is a graph comparing crosstalk to signal.

FIGS. 11a-11d are illustrations of embodiments of independent E-fields.

FIG. 12 is a high-level illustration of an interconnect card that may be used in conjunction with a waveguide.

FIG. 13 is a block diagram of an example layered protocol stack.

FIG. 14 is a block diagram illustrating selected components of a data center with network connectivity.

FIG. 15 is a block diagram illustrating selected components of an end-user computing device.

FIG. 16 is a block diagram of a software-defined infrastructure (SDI) data center.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples, or in some cases across different FIGURES. This repetition is for the purpose of simplicity and clarity and does not in itself dictate a specific relationship between the various embodiments and/or configurations discussed. Different embodiments may have different advantages, and no particular advantage is necessarily required of any embodiment.

A contemporary computing platform may include a complex and multi-faceted hardware platform provided by Intel®, another vendor, or combinations of different hardware from different vendors. For example, in a large data center such as may be provided by a cloud service provider (CSP) or a high-performance computing (HPC) cluster, the hardware platform may include rack-mounted servers with compute resources such as processors, memory, storage pools, accelerators, and other similar resources. As used herein, “cloud computing” includes network-connected computing resources and technology that enables ubiquitous (often worldwide) access to data, resources, and/or technology. Cloud resources are generally characterized by flexibility to dynamically assign resources according to current workloads and needs. This can be accomplished, for example, by assigning a compute workload to a guest device, wherein resources such as hardware, storage, and networks are provided to a virtual machine, container, or disaggregated node by way of nonlimiting example.

In embodiments of the present disclosure, a processor may include any programmable logic device with an instruction set. Processors may be real or virtualized, local or remote, or in any other configuration. A processor may include, by way of nonlimiting example, an Intel® processor (e.g., Xeon®, Core1υ, Pentium®, Atom®, Celeron®, x86, or others). A processor may also include competing processors, such as AMD (e.g., Kx-series x86 workalikes, or Athlon, Opteron, or Epyc-series Xeon workalikes), ARM processors, or IBM PowerPC and Power ISA processors, to name just a few.

Interconnects are an important part of any integrated computer system that requires communication. In most cases, the speed and bandwidth of an interconnect represent a limiting factor of the speed of the system as a whole. A majority of computing systems can process data more quickly internally than they can communicate the data to an outside system. This is true both within the chassis (e.g., a direct memory access bus, or a Northbridge or a Southbridge) and between computing devices (e.g., within a network).

As more computing moves to the data center, network demands increase. For example, many existing data centers have interconnects that operate in the 10 to 50 gigabit (Gb) per second range. However, following a pattern similar to “Moore's Law,” the required speeds in the data center are expected to double past 100 Gb per second by 2020, and then continue to double every few years thereafter. Increasing network speeds to handle the ever-increasing data demands on the data center introduces design complexities. These design complexities increase as users consume more and more data, and as more and more data are stored remotely from the devices that are consuming them (e.g., in “clouds”).

In cloud data centers, enterprise data centers, and other computing architectures that rely heavily on computer interconnects (such as HPC architectures), there may be multiple levels of interconnects between the various electronic devices hosted in a cluster. The various levels of interconnects can include, by way of illustrative and nonlimiting example, connections within a blade, connections within a rack, rack-to-rack connections, rack-to-switch connections, and switch-to-switch connections.

Traditionally, the longer interconnects (such as rack-to-switch and switch-to-switch) are provided via very high-speed fiber optic interconnects. Because fiber optic data travel at literally the speed of light (in that medium), the speed of these interconnects is limited only by the speed of modulating pulses. While this provides very high-speed communication, fiber optic interconnects are generally more expensive and power-hungry than other interconnects.

Shorter interconnects, such as those within the rack in some rack-to-rack communications, can be implemented with electrical cables such as Ethernet cables, coaxial cables, twinaxial cables, and similar. The selection of a cable may depend on the desired data rate.

As higher performance architectures are required, these traditional electrical cabling approaches may be inadequate to support the required data rates. In cases where they can be modified to support the required data rates, they become expensive and power-hungry, similar to optical cables. For example, the operational length and speed of an electrical cable can be extended by using higher quality materials, new materials, and advanced techniques such as equalization, modulation, and data correction. While these can effectively increase the speed and length of these types of connections, they can also be very expensive.

The challenges are particularly keen in the millimeter frequency band, which ranges from tens of gigahertz (GHz) to hundreds of gigahertz (specifically, 30 GHz to 300 GHz). In the millimeter frequency band, waveguides provide a practical solution that is lower cost than optical cabling, but yields higher speeds than traditional electrical interconnects. Note that while an electrical conductor will generally conduct in transverse electromagnetic (TEM) modes, a waveguide is more likely to operate in transverse electric (TE) modes or other non-TEM modes.

Rigid hollow metallic waveguides provide very high theoretical performance, but they are inflexible and heavy, and thus are not practical as cabling. Lower weight and greater flexibility can be realized by providing a dielectric waveguide (DWG). A dielectric waveguide could be as simple as a conductive foil in a cylindrical form factor, which has only air filling the waveguide. However, such waveguides can be prone to kinking and can be very fragile. Thus, a more common design is a cylindrical or rectangular waveguide that shares some attributes with traditional coaxial cables. The waveguide may have an external coating or sheathing to provide basic protection. This could be, for example, PVC or other flexible material. Within this may be a conductive foil or mesh, made of copper, aluminum, or other conductive material. This houses a dielectric which provides the actual waveguide. In some cases, the dielectric material also has a layer of cladding around it, which need not function as a waveguide, but provides structural support and protection. The cladding could be, for example, a foam or other dielectric material. The inner core of the dielectric waveguide is a material with a dielectric constant higher than that of the cladding, if any, that acts as the actual waveguide. A launcher drives signals into the dielectric medium, which are then received at the other end of the connection by a receiver.

Millimeter waveguide communication offers substantial advantages in terms of bandwidth density and transmission distance, as compared to standard copper or other electrical interconnects. Advantageously, waveguides do not require complex integration of active and passive optical components as is required in optical communications. Thus, millimeter waveguides offer a useful “middle ground” between the highest-speed fiber optic interconnects and available electrical interconnects.

Waveguides do, however, encounter substantial challenges. One challenge is in the transmission of very high frequencies (e.g., between approximately 300 GHz and up to 1 THz). Standard waveguides, with a dielectric waveguide core and a conductive coating become very lossy at high frequencies, on the order of 15 to 20 decibel (dB) per meter or more. This can significantly impact the overall link budget and the energy efficiency of the communication (measured, for example, in picojoules per bit). In designing a functional waveguide, it is desirable to have losses more on the order of 1 to 5 dB per meter.

Much lower loss can be realized by removing the conductive shielding around the dielectric waveguide core. However, removal of the conductive shielding also has some disadvantages. An unshielded waveguide operates in a hybrid non-TEM mode and has much lower losses, on the order of less than 5 dB per meter. In this transmission mode, much of the power of the signal is propagated around the edges of the waveguide medium. This can make the waveguide more susceptible to interference, and can result in crosstalk between waveguides. In a completely unshielded waveguide, a technician who simply touches the waveguide to move the cable would effectively destroy communication. Furthermore, two waveguides in close proximity could destructively interfere with one another or could cause crosstalk.

As system performance in data centers and other networking applications increases, there is higher demand for aggressive scaling of I/O bandwidth. Aggressive scaling of I/O bandwidth can include a requirement for higher interconnect density and denser packaging. As packaging density increases, crosstalk becomes a substantial challenge. Although some solutions seek to eliminate or to mitigate crosstalk, it is impossible to create a theoretically crosstalk-free channel.

The multimode waveguides disclosed herein can be used by way of nonlimiting example for millimeter wave and terahertz (THz) waveguide interconnects that are useful in applications such as those up to about 5 meters distance in data centers and high-performance computing applications. These applications require waveguide signaling technology that maximizes achievable throughput while minimizing power consumption by optimizing link power efficiency. Waveguide dispersion can severely limit the achievable data rate, and thus throughput. Furthermore, cross-sectional cabling bandwidth density should be maximized as well. In the case of purely dielectric waveguides that exhibit lower dispersion, this leads to problems with crosstalk between signaling lanes.

According to the teachings of the present specification, rather than attempting to create a crosstalk-free channel, there is disclosed herein a high-density multimode waveguide link. Multimode signaling offers the ability to improve waveguide density by transmitting signals without any crosstalk noise. To achieve multimode signaling, in one possible approach first a set of baseline codec coefficients and timing parameters may be derived from the scattering (“S”) parameters extracted from the baseline channel design. Then, the different components in the waveguide channel are designed for skew and impedance, so as to minimize the root mean square (RMS) jitter and maximize channel density.

There is shown here one illustrative design methodology for generating multimode signals. This should be understood as only one nonexclusive and illustrative method. This design methodology includes three steps. First, parameterized models of the process control block (PCB) or packaging may be built using 2D or 3D electromagnetic (EM) simulation. In order to achieve routing density, the baseline channel may be constructed at the highest possible density allowed by the manufacturing design rules. Then, S-parameters may be extracted from each model and cascaded to form the model of the full channel, which may be used to generate the transmitter and/or receiver codecs for multimode signaling via a recursive optimization algorithm. Once the codec is generated, it may be implemented into a fully programmable multimode transceiver. The resulting eye diagram can determine whether wider spacing between waveguides or any other modifications are required for the waveguide design. By iterating through the above steps, the channel density may be maximized while maintaining control over signal quality.

For arbitrary n channel networks (2n ports), the relationship between incident voltages and reflected voltages at each port may be described with the S-parameter of the network as:

$$[ \begin{matrix}{V}_{1}^{-} \\ {V}_{2}^{-} \\ ⋮ \\ {V}_{2 N}^{-}\end{matrix} ] = [ \begin{matrix}{S}_{11} & {S}_{12} & … & {S}_{12 N} \\ {S}_{21} & {S}_{22} & … & {S}_{22 N} \\ ⋮ & & ⋱ & \\ {S}_{2 N 1} & {S}_{2 N 2} & … & {S}_{2 N 2 N}\end{matrix} ] [ \begin{matrix}{V}_{1}^{+} \\ {V}_{2}^{+} \\ ⋮ \\ {V}_{2 N}^{+}\end{matrix} ]$$

Here, Vⱼ⁺ is the voltage of the incident voltage at port j, and Vᵢ⁻ is the voltage of the reflected voltage at port i, and Sᵢⱼ is the ratio of the reflected voltage Vᵢ⁻ to incident voltage Vⱼ⁺ with all ports other than port j terminated with matched loads according to:

$${S}_{ij} = \frac{{V}_{i}^{-}}{{V}_{j}^{+}} \vert {V}_{k}^{+} = 0 for k \neq j$$

With the assumption of no reflections, a direct relationship between transmitted voltages and received voltages can be established with a reduced S-parameter matrix as shown in:

$$[ \begin{matrix}{V}_{N + 1}^{-} \\ {V}_{N + 2}^{-} \\ ⋮ \\ {V}_{2 N}^{-}\end{matrix} ] = [ \begin{matrix}{S}_{( N + 1 ) 1} & {S}_{( N + 1 ) 2} & … & {S}_{( N + 1 ) N} \\ {S}_{( N + 2 ) 1} & {S}_{( N + 2 ) 2} & … & {S}_{( N + 2 ) N} \\ ⋮ & & ⋱ & ⋮ \\ {S}_{2 N 1} & {S}_{2 N 2} & … & {S}_{2 NN}\end{matrix} ] [ \begin{matrix}{V}_{1}^{+} \\ {V}_{2}^{+} \\ ⋮ \\ {V}_{N}^{+}\end{matrix} ]$$

This can be abbreviated as Vₒᵤₜ equals SVᵢₙ, where Vᵢₙ and Vₒᵤₜ denote the voltages at the output of the transmitter and the input of the receiver, respectively. Note that a number of different matching termination schemes can be used.

In the reduced S-parameter matrix S, the magnitude of diagonal entries captures the insertion loss of each line, and the off-diagonal entries represent the far end crosstalk (FEXT) between lines. A crosstalk-free channel can be realized if S is diagonalized. The desired diagonalization can be implemented according to:

$$V \frac{cf}{out} = {T}^{- 1} {STV}_{in}$$

In this equation, the T matrix is the eigenvector matrix of S. The modified transfer function matrix T⁻¹ST is diagonal, indicating that all FEXT have been canceled out, where the

$$V \frac{cf}{out}$$

denotes the crosstalk-free voltages at the input of the receiver.

Because the entries of the S-parameter matrix S of the practical channel are complex numbers, to fully diagonalize S, the codec matrices T and T⁻¹ have to be complex as well. Phases of entries in matrices T and T⁻¹ represent input voltage-controlled phase shifts. It is difficult, however, to implement input voltage-controlled phase shifts for each coding entry in the transceiver circuits. Thus, the codec may be derived using the absolute values of the entries of S with the assumption that this will provide satisfactory performance.

In a passive configuration, the channel may be terminated by simple resistors on both ends with no cross-coupling terms. In theory, this yields a system with nonzero reflections. It is assumed that there is sufficient crosstalk cancellation of the resulting implementation for satisfactory performance. Because the S-parameter matrix is frequency-dependent, each frequency point corresponds to a different eigenvector matrix. Therefore, T and T⁻¹ are frequency-dependent, as well. To find the optimal setting, it may be necessary to determine the codec matrix that gives the highest overall signal-to-noise ratio performance. A figure of merit (FOM) may be introduced to represent the overall signal-to-noise ratio (SNR) as shown in:

$$FOM = {\sum }_{freq = 0}^{fknee} min \{ \frac{\vert ( {T}^{- 1} ST ) diagonal \vert}{\vert ( {T}^{- 1} ST ) off - diagonal \vert} \}$$

In this case, the knee frequency (fₖₙₑₑ) is the highest frequency content within a particular digital signal, which relates to the rise and fall times as shown in:

$${f}_{knee} \approx \frac{0.35}{{t}_{10 - 90 \%}}$$

For every eigenvector matrix T at any available frequency, the FOM is defined as the sum of SNRs (diagonal to off-diagonal entries) for frequencies from 0 to fₖₙₑₑ. Whichever frequency point gives the highest FOM provides the best overall SNR, and may be chosen as the codec generation frequency for multimode signaling.

Embodiments of the present specification combine multiple dielectric waveguides into a high-density, coupled waveguide interconnect operating, for example, at millimeter or terahertz frequencies. The waveguides disclosed herein may use crosstalk cancellation at the input and/or output of the interconnect, for example, based on multimode signaling techniques. Suitable encoders and decoders could be used at the transmitter and receiver side to provide mostly decoupled and crosstalk-free signals at the output of the interconnect system. This maximizes cabling bandwidth density while mitigating waveguide dispersion. This high-speed cabling helps to overcome bandwidth bottlenecks in next generation data centers and high-performance computing clusters.

A system and method for providing a multimode waveguide will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

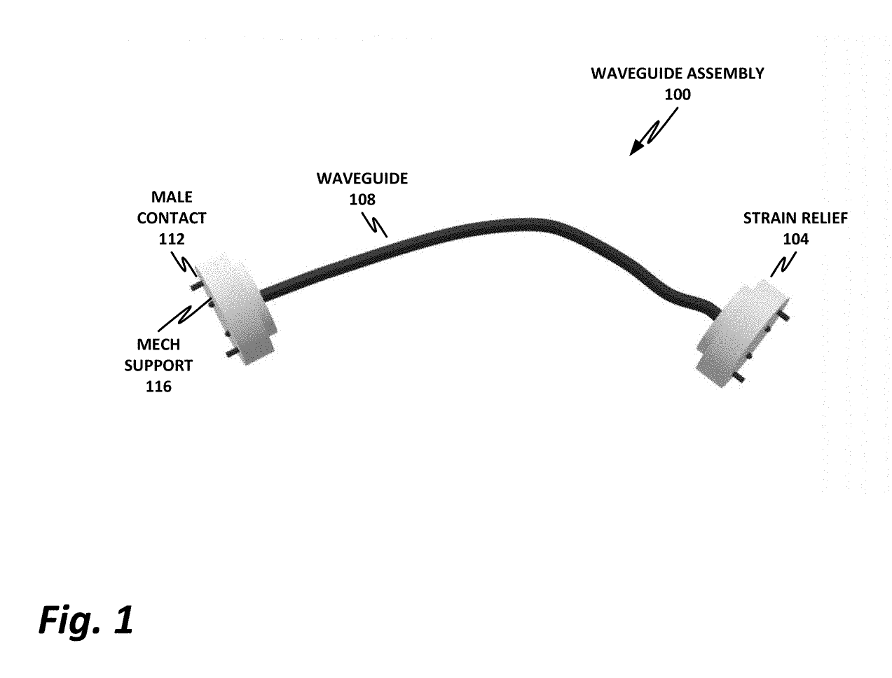

FIG. 1 is a perspective view of a waveguide connector 100. Embodiments of waveguide connector 100 disclosed herein may be adapted or configured to provide a multimode waveguide, according to the teachings of the present specification.

The general principles of waveguides are well-known. Waveguides can be contrasted with electrical conductors, which have substantially no field components in the longitudinal direction referred to as transverse electromagnetic (TEM) waves. In contrast, a waveguide has a single conductor (if it has a conductor at all), and generally does not support TEM waves. Rather, waveguides support transverse magnetic (TM) and transverse electric (TE) waves, among other non-TEM modes such as hybrid modes. The waveguides described in this specification generally include a dielectric propagation medium that optionally may be surrounded by a conductive shield. These waveguides generally operate in a non-TEM mode.

Waveguide connector 100 is illustrated as a high-level connector, and can represent several different kinds of waveguides.

A simple waveguide is a metallic rectangular waveguide. In the case of a metallic rectangular waveguide, a dielectric ribbon or round core is metal-coated and connectorized at both ends with strain relief 104, along with mechanical supports 116 and, optionally, male contacts 112. Note that male contacts 112 do not necessarily interface to electric circuitry for electrical transmission. Rather, mechanical supports 116 and male contacts 112 may provide a mechanical and structural guide to ensure that waveguide connector 100 interfaces properly to launchers in the waveguide network card. In the case of waveguide connector 100, it is sufficient for the dielectric transmission medium to physically interface to the launcher, thus ensuring that when an EM wave is launched onto waveguide 108, it propagates into the correct dielectric medium.

In the case where waveguide connector 100 is a metallic rectangular waveguide, the waveguide may operate with relatively low losses up to 200 GHz. But as frequencies increase beyond the 300 GHz range and up to approximately 1 THz, the system becomes much lossier, with losses much greater than 15 dB per meter. This can impact the link budget and the energy efficiency of a millimeter wave sub-terahertz transceiver.

To reduce losses over length, waveguide connector 100 could be constructed with only a dielectric propagation medium and without the conductive shielding. This may be referred to as a dielectric-only waveguide. Known dielectric waveguides have much lower losses at the 300 GHz to 1 THz range, with losses generally in the range of 1 to 5 dB per meter. While such waveguides experience less loss, they may require relatively large cladding around the waveguide core, with a diameter of 2 to 4 times the core radius in the X-Y dimension. Because some of the EM wave power lies beyond or outside of the core dielectric material, an uncladded waveguide would be subject to interference simply by touching it or by being near another waveguide. However, with the cladding, the effective bandwidth density of the overall cable is reduced.

Other embodiments of waveguide connector 100 may include a metallic-coated, multi-material and multimode waveguide that can be utilized to increase bandwidth density, and/or for asymmetric full-duplex operation. This configuration increases the effective bandwidth density because it uses the cladding itself as a transmission medium. This approach also allows for full-duplex operation. Embodiments of such a waveguide could be adapted to use the multimode propagation of the present specification.

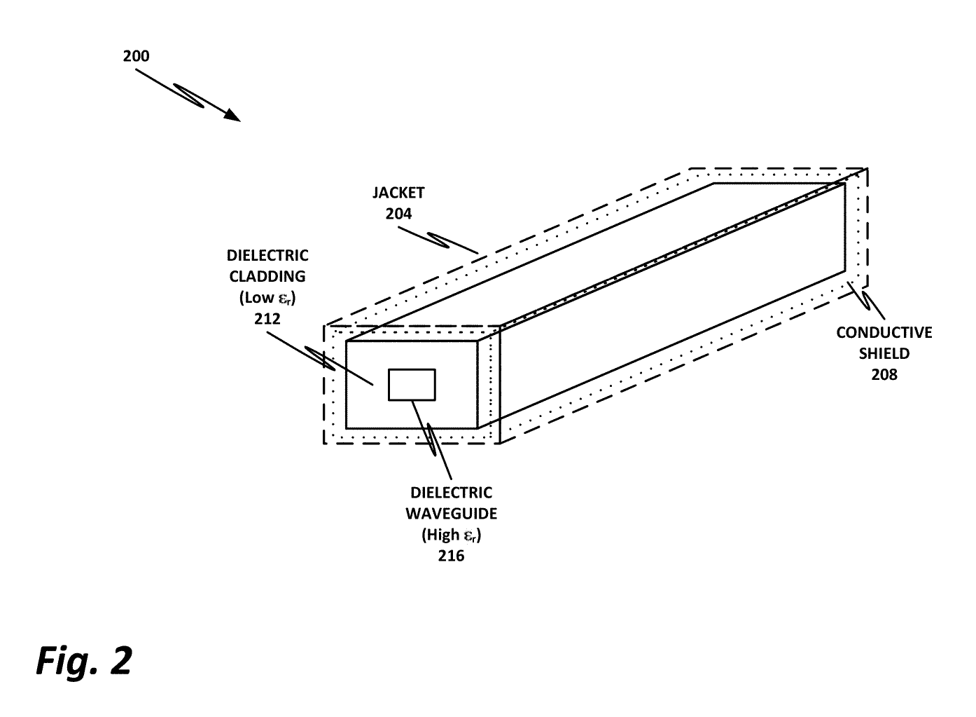

FIG. 2 is a perspective view of selected elements of a waveguide 200. Embodiments of waveguide 200 disclosed herein may be adapted or configured for multimode propagation, according to the teachings of the present specification.

Waveguide 200 may be configured so that signals propagate through both the dielectric waveguide core 216 and through dielectric cladding 212. By way of illustrative example, dielectric waveguide core 216 may have a relative permittivity εᵣ of approximately 3 to 20, while dielectric cladding 212 may have a relative permittivity Eᵣ down to about 1.5 or 1.6. Note that in this embodiment, there is no conductive shielding directly around dielectric waveguide core 216. The lack of conductive shielding around dielectric waveguide 216 helps to reduce transmission losses such that the losses through waveguide 200 are on the order of 1 to 5 dB per meter, instead of 15 to 20 or more dB per meter, at frequency ranges of approximately 300 GHz to 1 THz.

Dielectric cladding 212 can also be used for signal propagation, according to the teachings of the present specification. Dielectric cladding 212 has a lower εᵣ than dielectric waveguide core 216, such as on the order of 1.5 or 1.6. Although dielectric cladding 212 may not support propagation of signals as high in frequency as dielectric waveguide core 216, lower frequency signals can be propagated through dielectric cladding 212. For example, signals with a frequency of 50 to 60 GHz can propagate through dielectric cladding 212. Because high-frequency losses are of less concern, dielectric cladding 212 can be surrounded by conductive shield 218. Finally, the entire assembly can have a nonconductive jacket 204, such as PVC or other covering material that provides some physical protection, and also cosmetic benefits, to add to waveguide 200. By using both cladding 212 and waveguide 216 for signal propagation, the overall bandwidth density of waveguide 200 is increased.

In a more generalized case, dielectric waveguide core 216 may serve as a transmission medium for greater than 200 GHz EM waves, while cladding material 212 may serve as a transmission medium for less than 200 GHz EM waves.

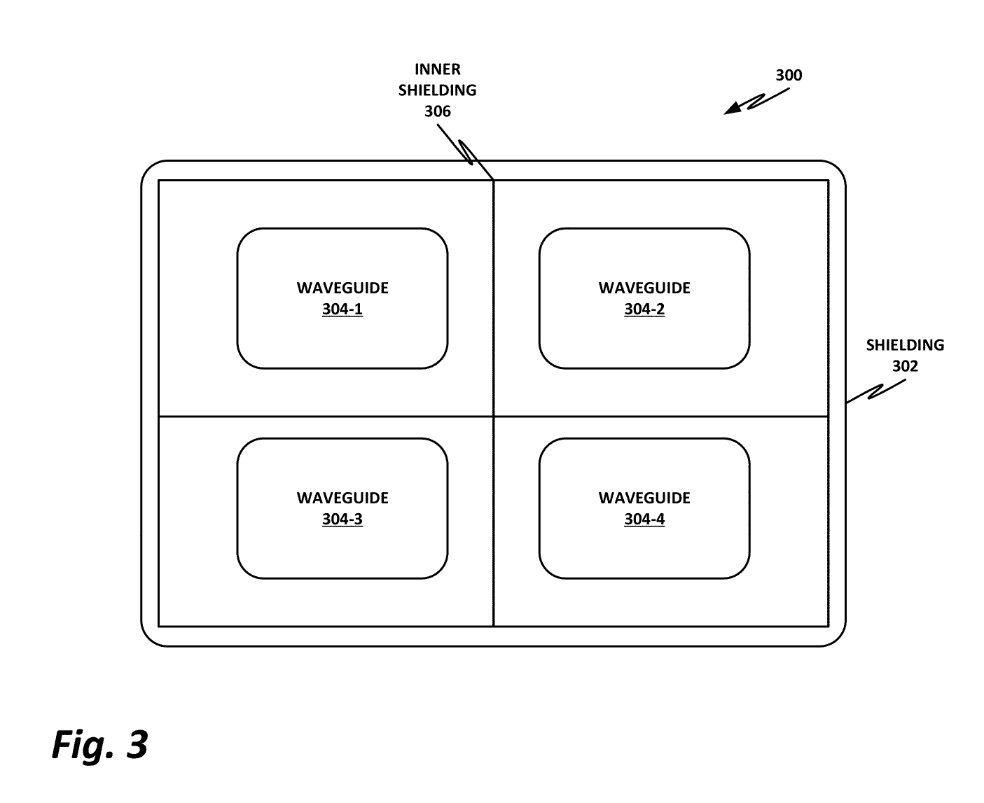

In this illustration, dielectric waveguide 216 is shown concentric with, and in the middle of, dielectric cladding 212. This configuration is shown in FIG. 3.

FIG. 3 is a cutaway front view of a waveguide 300, which may be an embodiment of or a different waveguide from waveguide 200 of FIG. 2. Embodiments of waveguide 300 may be adapted or configured to provide a multimode waveguide, according to the teachings of the present specification.

Waveguide 300 is constructed of a relatively high εᵣ material, and may be provided with cladding constructed of a low εᵣ material. Waveguide cores 304 do not have any conductive shielding directly around them, but the cladding can have shielding 302 around it. In one specific example, waveguide cores 304 are rectangular, with dimensions of approximately 200 μm×400 μm or less for greater than 200 GHz operation. The cladding may have dimensions of 1.5 mm×3 mm or less for approximately 50 GHz operation, or operation between 50 GHz and 200 GHz.

Also note that in one embodiment, shielding 302 runs substantially along one edge of waveguide cores 304. In this case, the system uses ground cladding as an image plane, and the waveguide height may be reduced by half. In other words, rather than being 200 μm×400 μm, the waveguide cores 304 may be approximately 100 μm×400 μm. Note that all embodiments are shown by way of nonlimiting, illustrative example only, and other embodiments are possible, including an embodiment wherein either 200 μm×400 μm waveguide cores or 100 μm×400 μm waveguide cores are used in waveguide 300.

Single, purely dielectric waveguides such as waveguide cores 304 support a fundamental mode without low-frequency cutoff. An example is the hybrid HE₁₁ mode of circular dielectric waveguides. This type of mode exhibits relatively low waveguide dispersion and can be utilized for high-speed signaling operations at millimeter wave or terahertz frequencies. But the open boundary nature of such dielectric waveguides leads to the need for relatively bulky metallic shielding around the individual waveguides as illustrated by inner shielding 306 of waveguide 300. This limits the achievable bandwidth density of cables constructed with multiple waveguides, as illustrated herein.

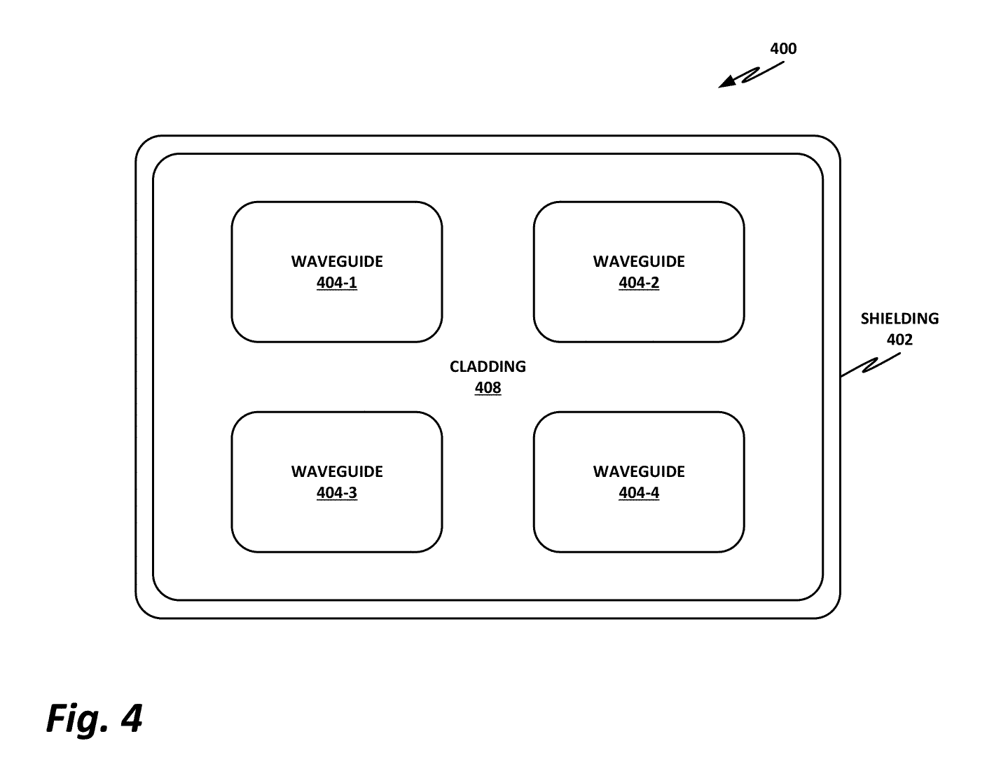

FIG. 4 is a cutaway front view of a waveguide 400 providing bundled, unshielded dielectric waveguides. In this example, shielding 402 still encases waveguide 400, and cladding 408 is provided. A plurality of waveguide cores, namely waveguide core 404-1, 404-2, 404-3, and 404-4, are provided.

Common outer shielding 402 prevents radiation loss at bends or discontinuities, and prevents bundle-to-bundle crosstalk (e.g., in bundles of bundles). This arrangement leads to very high waveguide density, but waveguide coupling would normally lead to excessive crosstalk, which would limit the achievable bandwidth density at the cable level.

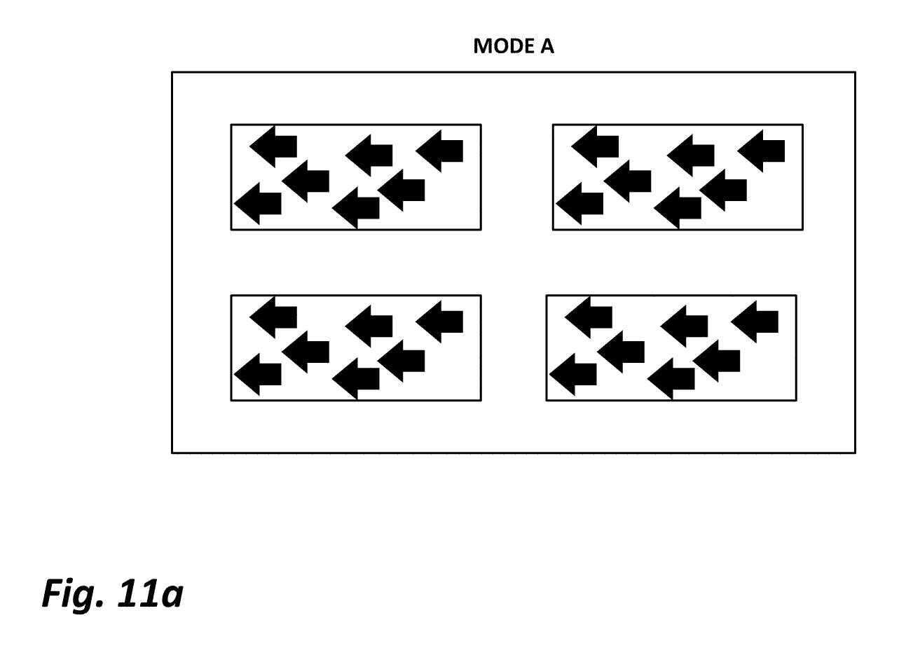

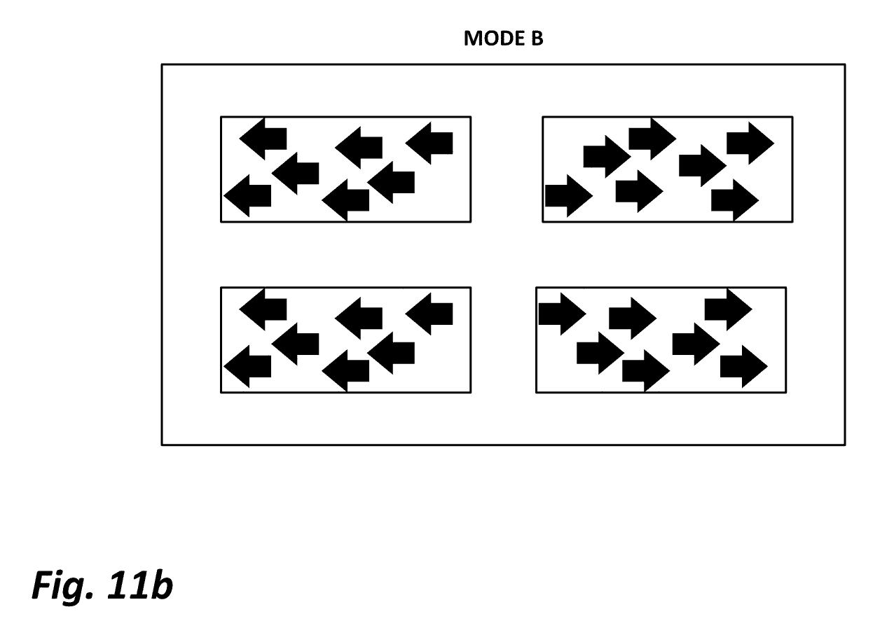

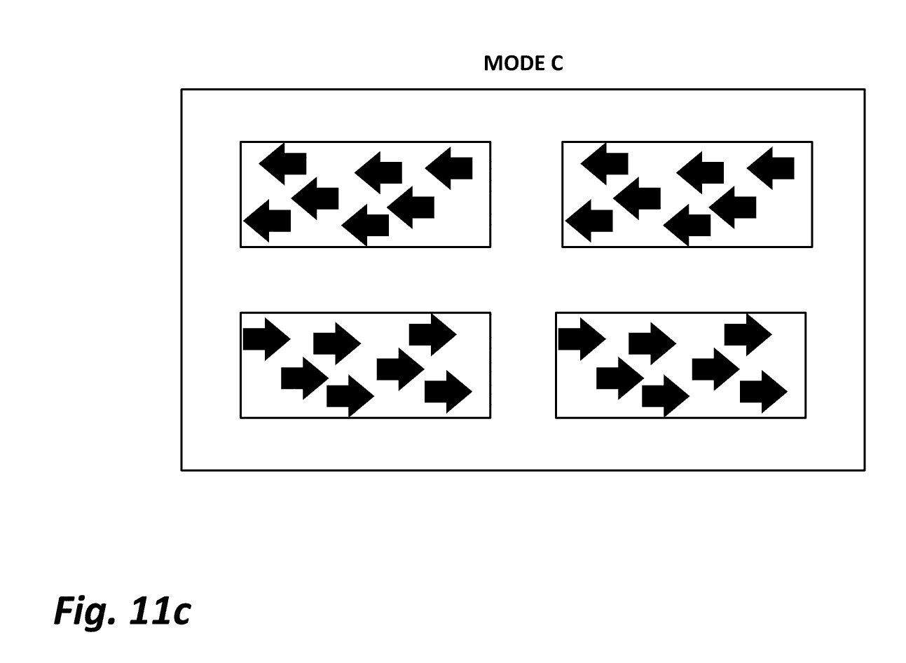

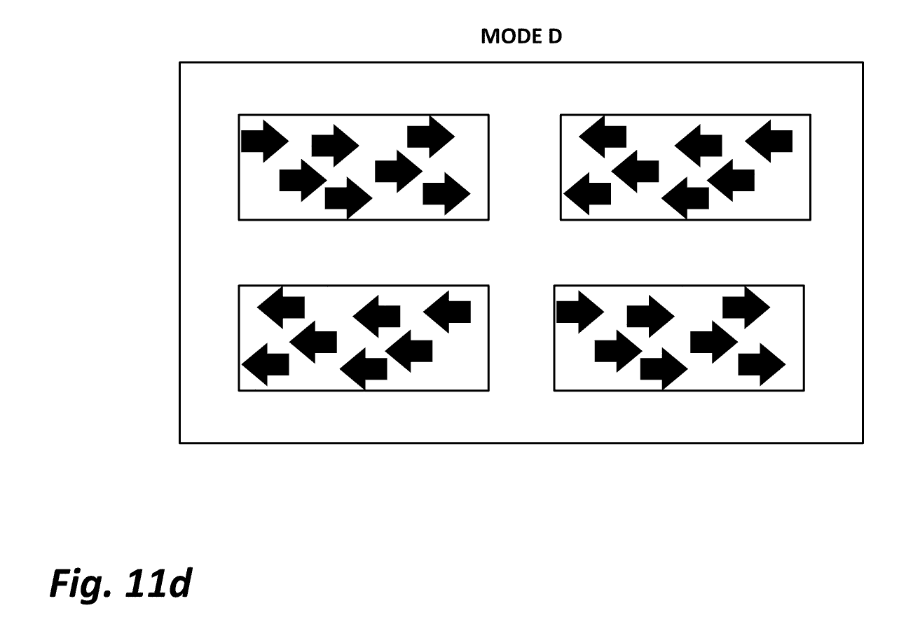

To overcome this limitation, dense bundling of waveguide cores may be combined with crosstalk cancellation devices at the input and/or output of the interconnect. These could be based, for example, on multimode signaling techniques as described above, using a suitable encoder/decoder at the transmit and/or receive ends. This provides mostly decoupled and crosstalk-free signals at the output of the interconnect system. FIG. 11 provides a high-level illustration of an interconnect card that could be used in conjunction with waveguide 400 to realize these results. Variations of this configuration are based on having a combined encoder/decoder block at the input or output only, or any other suitable crosstalk cancellation device.

The described multimode signaling techniques operate in the baseband, and have been used successfully in conventional electrical interconnects, such as uniform multiconductor transmission line systems. These provide coupled microstrips and strip lines. These were later extended to scattering (S) parameter-based crosstalk cancellation to include 3D interconnects such as package vias, connectors, and sockets. Multiple input/multiple output (MIMO) techniques and emerging cross-coupled/matrix equalizers may also be utilized. The corresponding active circuitry is adapted to the millimeter wave or terahertz waveguide interconnects illustrated here.

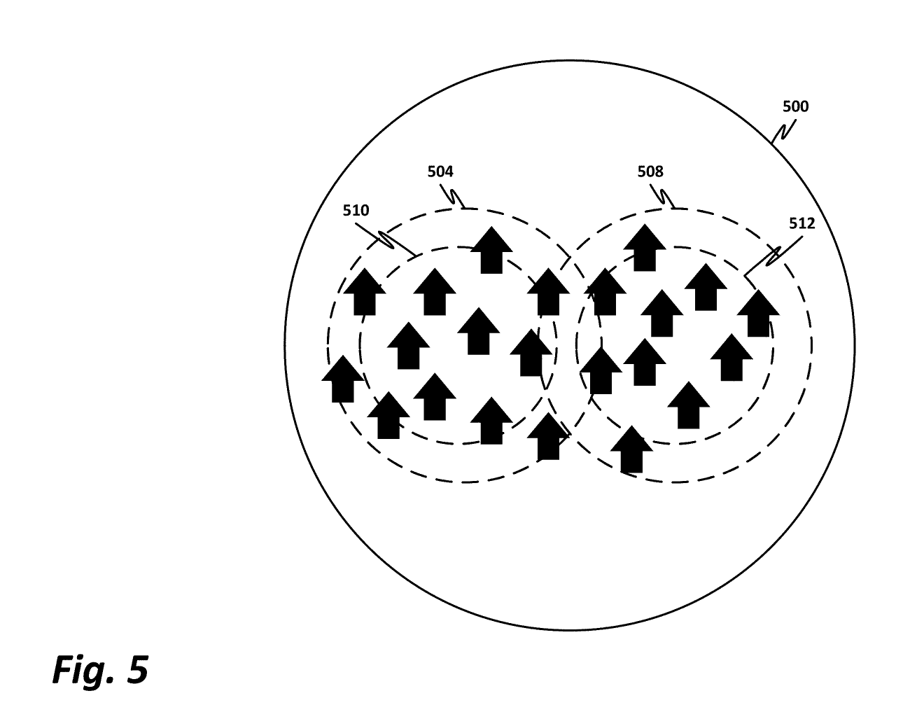

FIG. 5 is a block diagram of a waveguide 500, including a first waveguide conduit 510 and a second waveguide conduit 512. In this illustration, the two circular waveguides 510, 512 provide an even mode of propagation (Σ), as can be seen by the respective partial E-fields 504 and 508, wherein the fields are directionally aligned. If this mode is transmitted along with another transmission that also has an even mode component, then substantial coupling may occur between the transmissions.

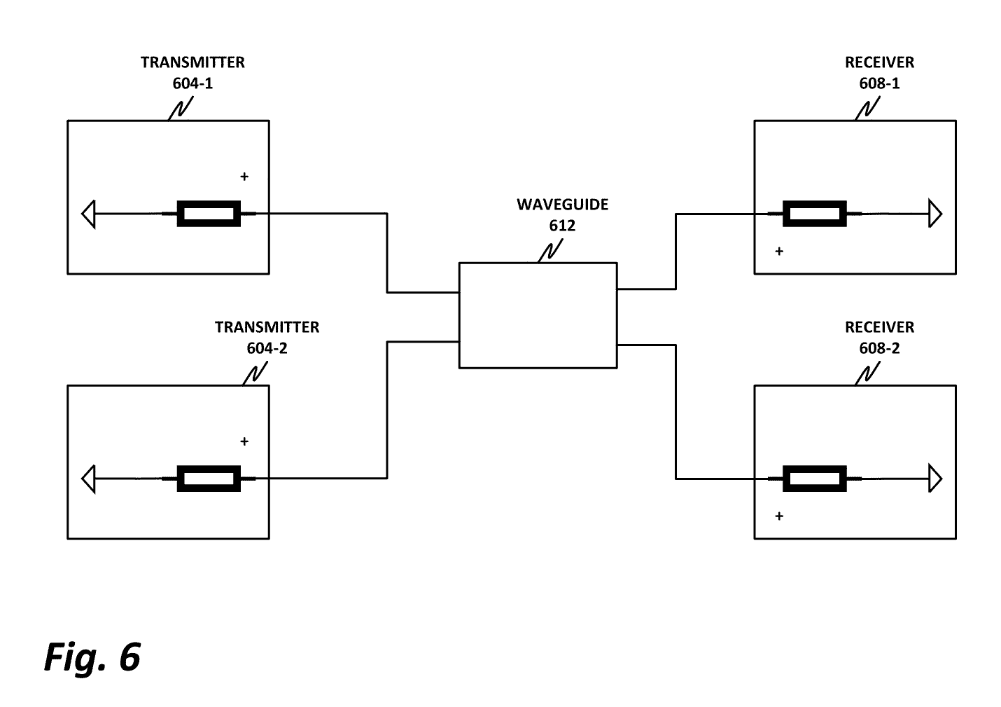

FIG. 6 is a block diagram of a passive transmitter pair 604-1, 604-2, and a passive receiver pair 608-1, 608-2. Transmitter 604-1 may, for example, transmit via waveguide 510 of FIG. 5, while transmitter 604-2 may transmit via waveguide 512 of FIG. 5. Waveguide 612 illustrated here may be considered an example or embodiment of waveguide 500 of FIG. 5. Receiver 608-1 receives a signal from transmitter 604-1, while receiver 608-2 receives the signal from transmitter 604-2.

This combination of passive transmitters and receivers may result in transmitting the superposition of two non-orthogonal fields. For example, the fields may both contain components of the even mode of substantially the pattern of FIG. 5.

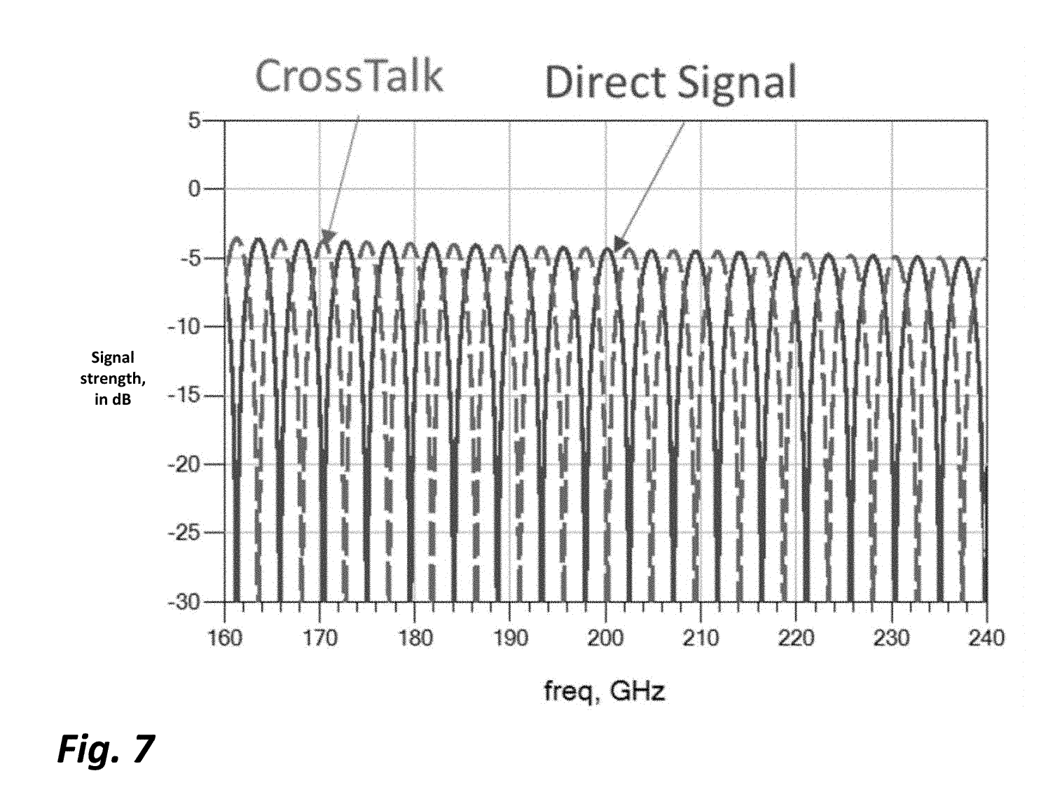

The difficulties of such a transmission can be seen in FIG. 7, which is a graph illustrating the transmission characteristics of this transmitter-receiver pair. This graph illustrates both crosstalk and direct signal between 160 GHz and 240 GHz. On the Y axis, there is illustrated signal strength in dB.

As can be readily seen here, the direct signal is not smooth, but has substantial valleys and is interrupted by crosstalk. This means that when transmitter 604-1 transmits its signal to receiver 608-1, a substantial portion of the transmitted power arrives at receiver 608-2, where it shows up as noise. A similar result happens when transmitter 604-2 leaks a substantial portion of its power to receiver 608-1. The result is that both signals are weak and noisy. This may be unacceptable for communication purposes.

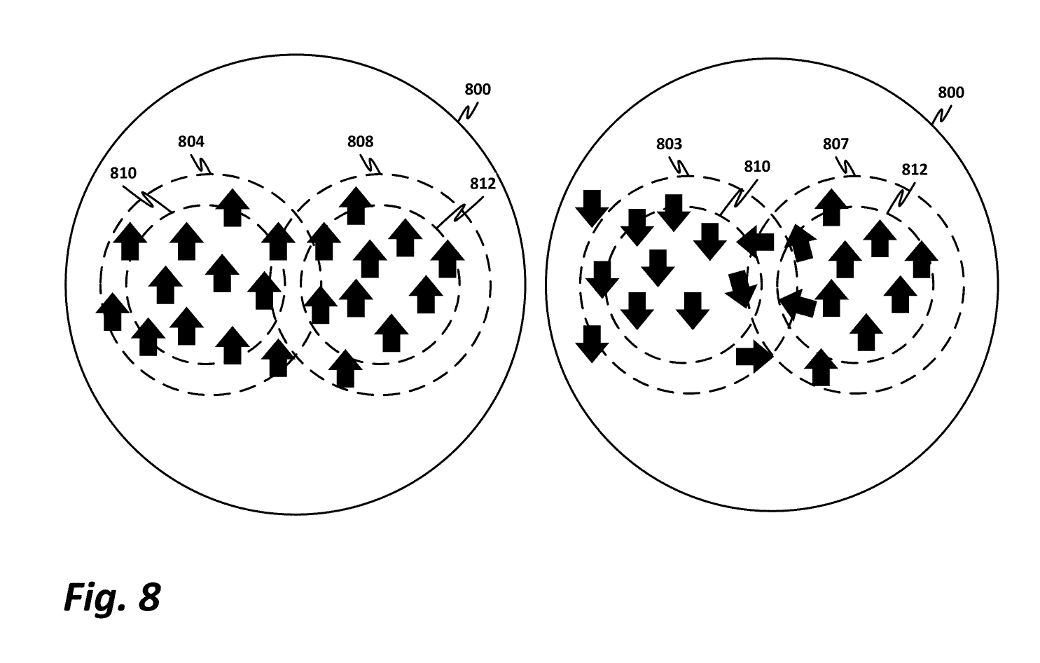

FIG. 8 illustrates an example of a waveguide 800 in which two inner waveguides, namely 810 and 812, are provided. The respective partial E-fields 803 and 807 are substantially aligned in opposite directions. This provides an odd mode of propagation (Δ). FIG. 8 also shows partial E-fields 804 and 808 that form the even mode of propagation Σ of FIG. 5 and that may exist on waveguide 800 at the same time, in linear superposition with A.

The odd mode may be transmitted, for example, alongside the even mode of propagation. Because the even and odd modes (Σ and Δ) are linearly independent of each other and may be orthogonal (i.e., integration of the dot vector product of the respective E-fields over the waveguide cross-section is zero) or nearly orthogonal, the correct information can be constructed at the transmitter, such as by using a matrix multiplication, and can be reconstructed at the receiver using an inverse matrix multiplication. These operations could be provided in active circuitry, such as in digital logic.

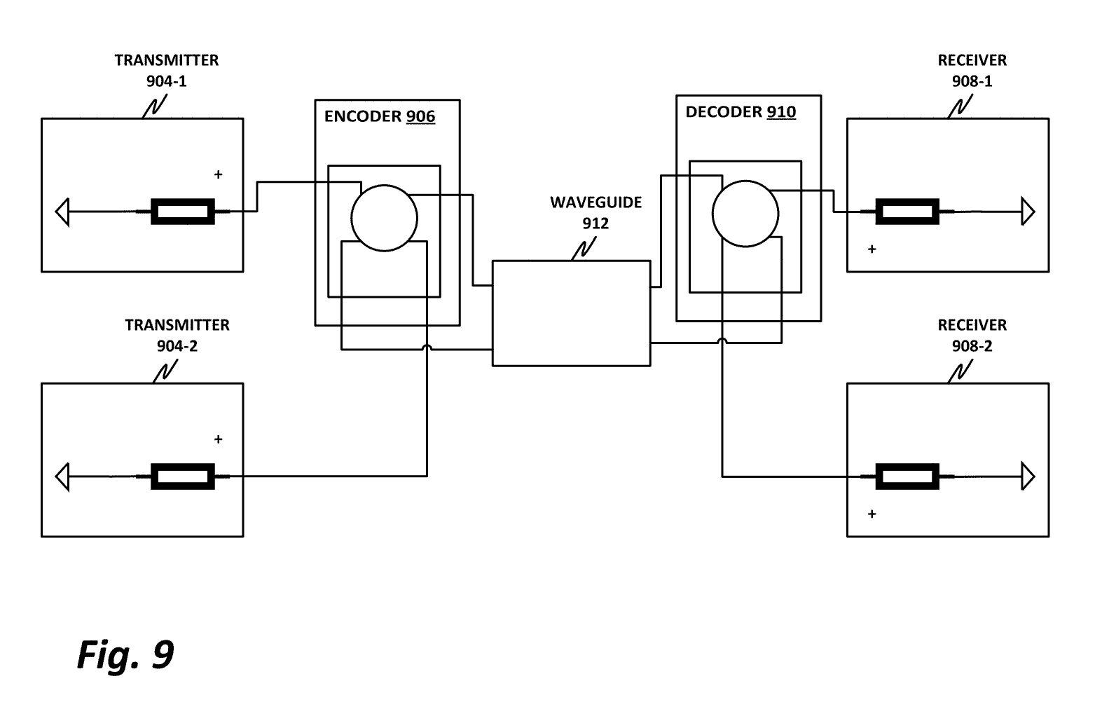

FIG. 9 is a block diagram of a transmitter and receiver pair. In this case, waveguide 912 may again be an example of waveguide 500 of FIG. 5 or waveguide 800 of FIG. 8. Transmitters 904-1 and 904-2 are transmitting signals to receivers 908-1 and 908-2, respectively. These signals are passed through an analog encoder 906, which may include a 180° hybrid junction (or “rat race”). The operation of this 180° hybrid junction corresponds to a 2×2 matrix multiplication.

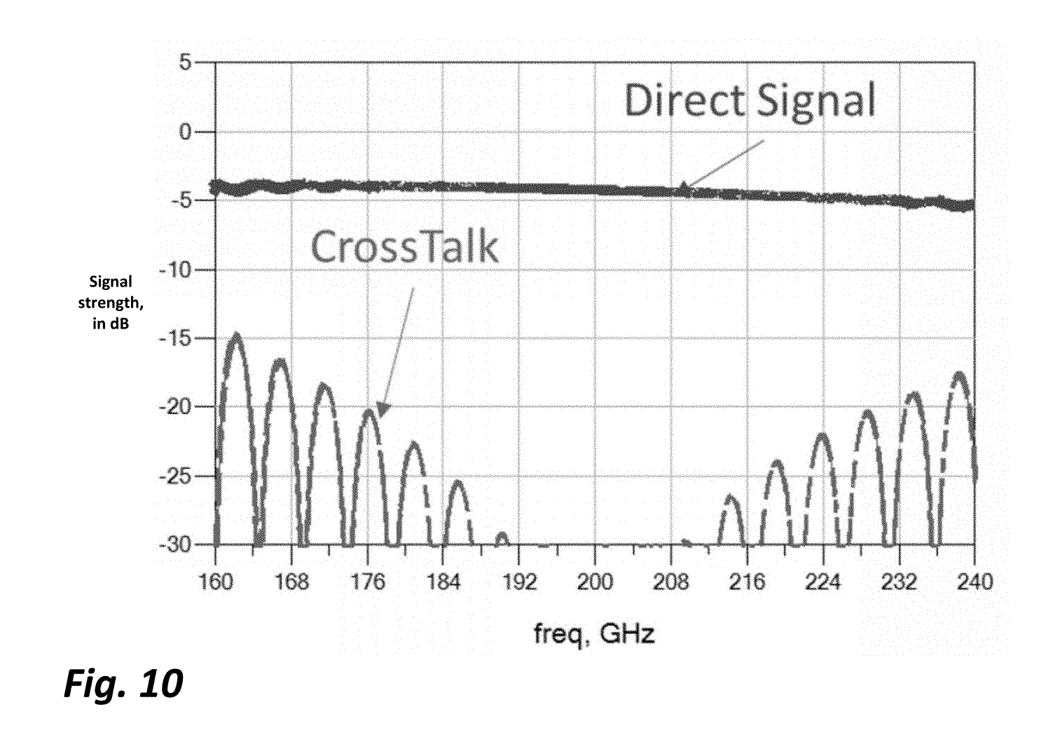

At the output side, decoder 910 also provides a 180° hybrid junction, which corresponds to an inverse 2×2 matrix multiplication. Thus, receiver 908-1 and receiver 908-2 receive essentially decoupled signals. The result can be observed in FIG. 10, where the direct signal is much stronger than the crosstalk, and is easily separated from the crosstalk. The direct signal strength is also flatter and smoother.

For more than two waveguides per bundle, more complex phase distribution may be required to effectively excite (encode) the modes of the structure and decode the resulting signals on the opposite side. This may require in some cases an example of different linearly independent modes. For example, if four waveguides are used, four different signals may be encoded in four different modes. This can be done through a network of passive radio frequency (RF) interconnects or through active circuitry that provides encoding in the baseband.

FIGS. 11a-11d are illustrative diagrams of four independent E-field modes that together may be used for multimode signaling according to the teachings of this specification. These illustrations assume four waveguide cores, though any suitable number of waveguide cores may be used. FIGS. 11a-11d illustrate four fields that are independent non-TEM modes, i.e., each one of FIGS. 11a-11d shows one such mode. These modes may be linearly independent, and in some embodiments, may be orthogonal or nearly orthogonal. The modes are orthogonal when the dot vector products add up (i.e., integrate) to zero across the cross-section of the waveguide. For example, to show orthogonality between Mode A and Mode B, the dot vector product of the electric field vector of Mode A times the electric field vector of Mode B may be calculated at each location of the cross-section, and the products are summed (i.e., integrated over the cross-section). If the sum is zero, the modes are orthogonal, and if the sum is substantially or nearly zero (as for example compared to the integrated product of either mode times itself, i.e., the normalized power), the modes are nearly orthogonal. For example, Mode A is illustrated in FIG. 11a, Mode B is illustrated in FIG. 11b, Mode C is illustrated in FIG. 11c, and Mode D is illustrated in FIG. 11d. Mode A is orthogonal to Modes B, C, and D. Mode B is orthogonal to Modes A, C, and D. Mode C is orthogonal to Modes A, B, and D. Mode D is orthogonal to modes A, B, and C.

Because the modes are orthogonal (or at a minimum, linearly independent), the four modes may be used to transmit four components of a transmission without destructive crosstalk or interference.

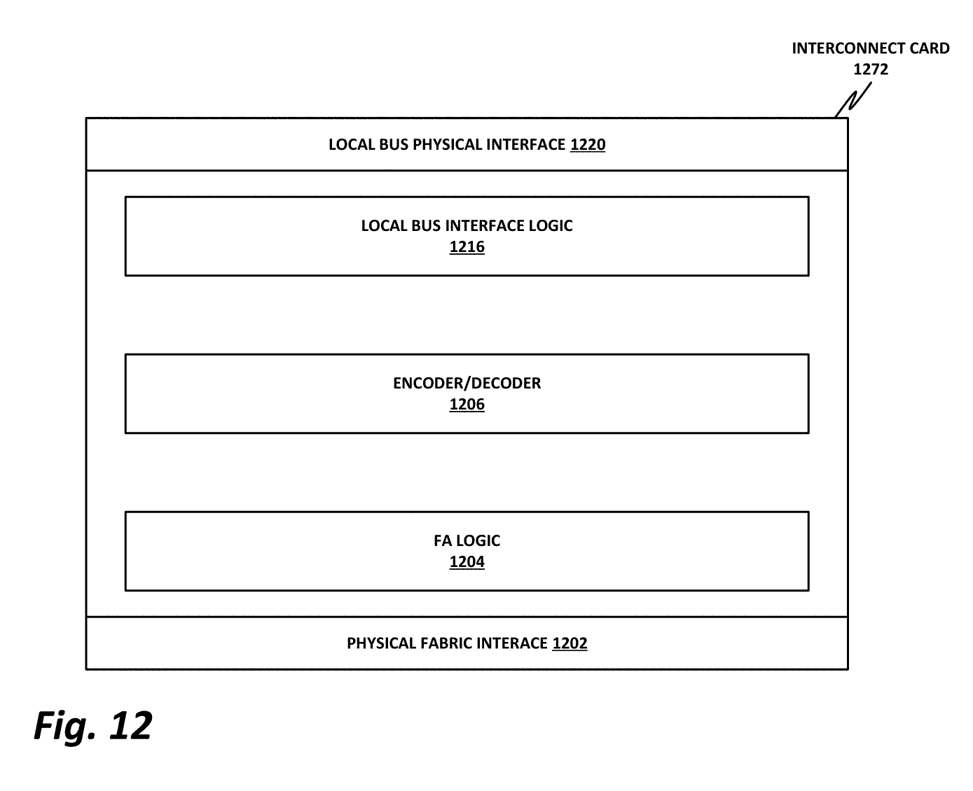

FIG. 12 is a high-level illustration of an interconnect card 1272 that could be used in conjunction with waveguide 400. Interconnect card 1272 is provided by way of nonlimiting example only. It should be noted in particular that interconnect card 1272 may be a separate pluggable card, such as a peripheral component interconnect express (PCIe) card, or it may be tightly integrated and on-die with its host core.

Furthermore, while interconnect card 1272 is disclosed herein as the medium for hosting remote hardware acceleration functions, these functions could just as well be hosted in another part of the machine. For example, a dedicated remote hardware acceleration (RHA) chip could be provided, which itself could be very much like a hardware accelerator. Functions could be performed on a hardware block integrated into the core, or these functions could be performed in software on the core. Thus, the disclosure of remote hardware acceleration functions on interconnect card 1272 in this FIGURE should be understood as a nonlimiting and illustrative example only, and the present disclosure should be understood to encompass any suitable hardware or software configuration for realizing remote hardware acceleration.

In this example, interconnect card 1272 includes two physical interfaces, namely a local bus physical interface 1220 and a physical fabric interface 1202.

Local bus interface 1220 may provide a physical interface to a local bus on the host, such as a PCIe interface or other local interconnect. Local bus physical interface 1220 is provided as a nonlimiting example, and it should be understood that other interconnect methods are possible. For example, in cases where interconnect card 1272 is tightly coupled with its accompanying core, local bus physical interface 1220 could be provided by direct, on-die trace lines, or direct copper connections on an integrated circuit board. In other examples, a bus interface other than PCIe could be used.

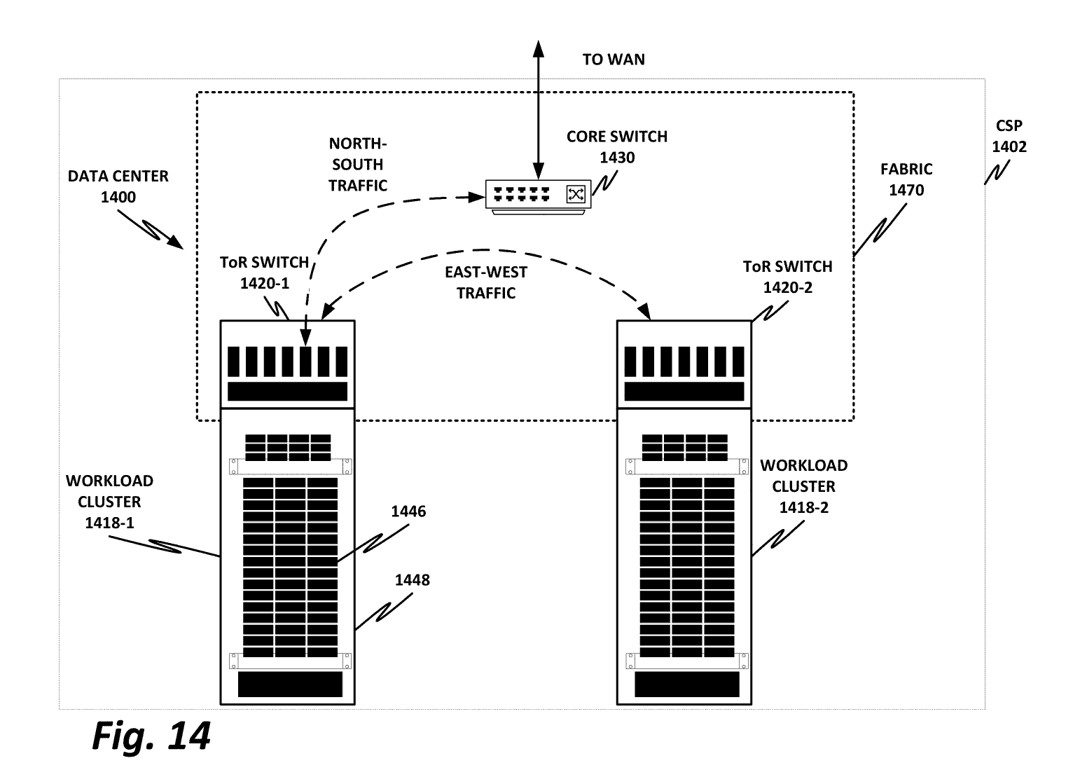

Physical fabric interface 1202 provides the physical interconnect to a fabric, such as fabric 1470 of FIG. 14 or any of the fabrics disclosed herein. Physical fabric interface 1202 may be configured to connect interconnect card 1272 to any suitable fabric.

In one particular example, the Intel® Omni-Path™ fabric may be used. The Omni-Path™ fabric is advantageous because it allows mapping of addresses and memory ranges between different coherent domains. A system may include one or more coherent domains wherein all coherent domains are connected to each other via a fabric. Caching agents are the coherency agents within a node that process memory requests from cores within the same node, thus providing the coherency of the domain. Home agents are node clusters that are responsible for processing memory requests from the caching agents, and act as a home for part of the memory address space. Multiple homes may be provided on a single die with a distributed address space mapping. Depending on the address space that a request targets, the request may be routed to the same node's local memory, or it may go to an Intel® UltraPath Interconnect (UPI) agent, for example, which may route the request to other processors within the same coherent domain. Alternately, a request may go through the interconnect card 1272 to processors that are outside the coherent domain. All processors connected via the UPI belong to the same coherent domain. Thus, in one embodiment, interconnect card 1272 may communicate with an Omni-Path™ fabric via UPI tunneling.

This communication may be facilitated via fabric adapter (FA) logic 1204, which provides logic elements and instructions necessary to provide communication within a coherent domain, and across the fabric with different coherent domains. FA logic 1204 may also include logic to translate local requests into remote fabric requests.

On the other hand, local bus interface logic 1216 may provide logic for interfacing with the local bus, such as a PCIe bus, or a dedicated copper connection. Alternately, traffic through interconnect card 1272 may follow a path through local bus physical interface 1220, local bus interface logic 1216, FA logic 1204, and physical fabric interface 1202 out to the fabric.

As illustrated, interconnect card 1272 may also provide encoder/decoder 1206, according to the teachings of the present specification. Encoder/decoder 1206 can include structures such as those illustrated in FIGS. 6 and 9, and may include active circuitry and structures to perform functional calculations in digital logic. By way of nonlimiting example, encoder/decoder 1206 may be provided as an application-specific integrated circuit (ASIC), a field-programmable gate array (FPGA), accelerator, or programmable logic, or as instructions provided in a digital signal processor (DSP), graphics processing unit (GPU), or any other processor appropriate to the teachings of the present specification.

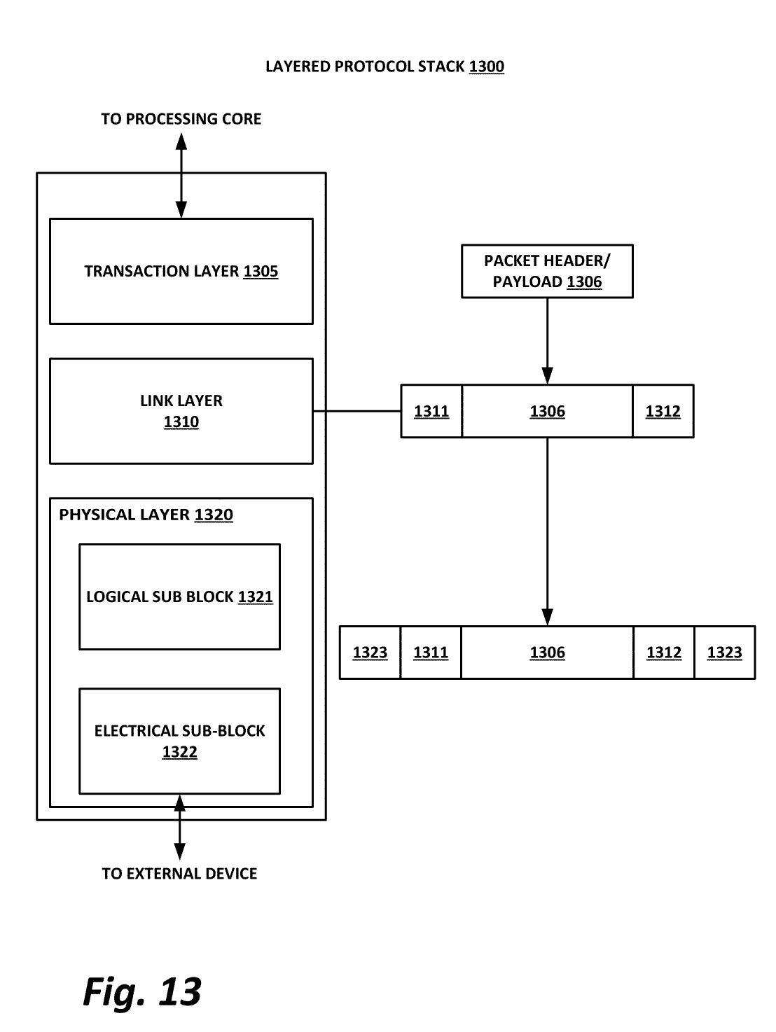

FIG. 13 is a block diagram of an example layered protocol stack 1300. Embodiments of layered protocol stack 1300 disclosed herein may be adapted or configured to provide a multimode waveguide, according to the teachings of the present specification.

Layered protocol stack 1300 includes any form of a layered communication stack, such as an Intel® QuickPath Interconnect (QPI) stack, a PCIe stack, a next generation HPC interconnect stack, or other layered stack. In one embodiment, protocol stack 1300 is a PCIe protocol stack including transaction layer 1305, link layer 1310, and physical layer 1320. Representation as a communication protocol stack may also be referred to as a module or interface implementing/including a protocol stack.

PCIe uses packets to communicate information between components. Packets are formed in the transaction layer 1305 and data link layer 1310 to carry the information from the transmitting component to the receiving component. As the transmitted packets flow through the other layers, they are extended with additional information necessary to handle packets at those layers. At the receiving side the reverse process occurs and packets get transformed from their physical layer 1320 representation to the data link layer 1310 representation and finally (for transaction layer packets) to the form that can be processed by the transaction layer 1305 of the receiving device.

Transaction Layer

In one embodiment, transaction layer 1305 is to provide an interface between a device's processing core and the interconnect architecture, such as data link layer 1310 and physical layer 1320. In this regard, a primary responsibility of the transaction layer 1305 is the assembly and disassembly of packets, i.e., transaction layer packets (TLPs). The translation layer 1305 typically manages credit-based flow control for TLPs. PCIe implements split transactions, i.e., transactions with request and response separated by time, allowing a link to carry other traffic while the target device gathers data for the response.

In addition, PCIe utilizes credit-based flow control. In this scheme, a device advertises an initial amount of credit for each of the receive buffers in transaction layer 1305. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more read requests and write requests to transfer data to/from a memory-mapped location. In one embodiment, memory space transactions are capable of using two different address formats, e.g., a short address format, such as a 32-bit address, or a long address format, such as a 64-bit address. Configuration space transactions are used to access configuration space of PCIe devices. Transactions to the configuration space include read requests and write requests. Message space transactions (more simply referred to as messages) are defined to support in-band communication between PCIe agents.

Therefore, in one embodiment, transaction layer 1305 assembles packet header/payload 1306. Format for current packet headers/payloads may be found in the PCIe specification at the PCIe specification website.

FIG. 14 is a block diagram illustrating selected components of a data center 1400 with network connectivity. Embodiments of data center 1400 disclosed herein may be adapted or configured to provide a multimode waveguide, according to the teachings of the present specification.

Data center 1400 is disclosed in this illustration as a data center operated by a CSP 1402, but this is an illustrative example only. The principles illustrated herein may also be applicable to an HPC cluster, a smaller “edge” data center, a microcloud, or other interconnected compute structure.

CSP 1402 may be, by way of nonlimiting example, a traditional enterprise data center, an enterprise “private cloud,” or a “public cloud,” providing services such as infrastructure as a service (laaS), platform as a service (PaaS), or software as a service (SaaS). In some cases, CSP 1402 may provide, instead of or in addition to cloud services, HPC platforms or services. Indeed, while not expressly identical, HPC clusters (“supercomputers”) may be structurally similar to cloud data centers, and unless expressly specified, the teachings of this specification may be applied to either. In general usage, the “cloud” is considered to be separate from an enterprise data center. Whereas an enterprise data center may be owned and operated on-site by an enterprise, a CSP provides third-party compute services to a plurality of “tenants.” Each tenant may be a separate user or enterprise, and may have its own allocated resources, service-level agreements (SLAB), and similar.

CSP 1402 may provision some number of workload clusters 1418, which may be clusters of individual servers, blade servers, rackmount servers, or any other suitable server topology. In this illustrative example, two workload clusters, 1418-1 and 1418-2 are shown, each providing rackmount servers 1446 in a chassis 1448.

In this illustration, workload clusters 1418 are shown as modular workload clusters conforming to the rack unit (“U”) standard, in which a standard rack, 19 inches wide, may accommodate up to 42 units (42U), each 1.75 inches high and approximately 36 inches deep. In this case, compute resources such as processors, memory, storage, accelerators, and switches may fit into some multiple of rack units from 1 U to 42 U.

In the case of a traditional rack-based data center, each server 1446 may host a standalone operating system and provide a server function, or servers may be virtualized, in which case they may be under the control of a virtual machine manager (VMM), hypervisor, and/or orchestrator. Each server may then host one or more virtual machines, virtual servers, or virtual appliances. These server racks may be collocated in a single data center, or may be located in different geographic data centers. Depending on contractual agreements, some servers 1446 may be specifically dedicated to certain enterprise clients or tenants, while others may be shared.

The various devices in a data center may be connected to each other via a switching fabric 1470, which may include one or more high-speed routing and/or switching devices. Switching fabric 1470 may provide both “north-south” traffic (e.g., traffic to and from the wide area network (WAN), such as the Internet), and “east-west” traffic (e.g., traffic across the data center). Historically, north-south traffic accounted for the bulk of network traffic, but as web services become more complex and distributed, the volume of east-west traffic has risen. In many data centers, east-west traffic now accounts for the majority of traffic.

Furthermore, as the capability of each server 1446 increases, traffic volume may further increase. For example, each server 1446 may provide multiple processor slots, with each slot accommodating a processor having four to eight cores, along with sufficient memory for the cores. Thus, each server may host a number of virtual machines (VMs), each generating its own traffic.

To accommodate the large volume of traffic in a data center, a highly capable switching fabric 1470 may be provided. As used throughout this specification, a “fabric” should be broadly understood to include any combination of physical interconnects, protocols, media, and support resources that provide communication between one or more first discrete devices and one or more second discrete devices. Fabrics may be one-to-one, one-to-many, many-to-one, or many-to-many.

In some embodiments, fabric 1470 may provide communication services on various “layers,” as outlined in the Open Systems Interconnection (OSI) seven-layer network model. In contemporary practice, the OSI model is not followed strictly. In general terms, layers 1 and 2 are often called the “Ethernet” layer (though in some data centers or supercomputers, Ethernet may be supplanted or supplemented by newer technologies). Layers 3 and 4 are often referred to as the transmission control protocol/internet protocol (TCP/IP) layer (which may be further sub-divided into TCP and IP layers). Layers 5-7 may be referred to as the “application layer.” These layer definitions are disclosed as a useful framework, but are intended to be nonlimiting.

Switching fabric 1470 is illustrated in this example as a “flat” network, wherein each server 1446 may have a direct connection to a top-of-rack (ToR) switch 1420 (e.g., a “star” configuration). Note that ToR is a common and historical name, and ToR switch 1420 may, in fact, be located anywhere on the rack. Some data centers place ToR switch 1420 in the middle of the rack to reduce the average overall cable length.

Each ToR switch 1420 may couple to a core switch 1430. This two-tier flat network architecture is shown only as an illustrative example. In other examples, other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The fabric itself may be provided by any suitable interconnect. For example, each server 1446 may include an Intel® Host Fabric Interface (HFI), a network interface card (NIC), intelligent NIC (iNIC), smart NIC, a host channel adapter (HCA), or other host interface. For simplicity and unity, these may be referred to throughout this specification as a “fabric adapter” (FA), which should be broadly construed as an interface to communicatively couple the host to the data center fabric. The FA may couple to one or more host processors via an interconnect or bus, such as PCI, PCIe, or similar, referred to herein as a “local fabric.” Multiple processor may communicate with one another via a special interconnects such as a core-to-core Intel® UltraPath Interconnect (UPI), Infinity Fabric, etc. Generically, these interconnects may be referred to as an “inter-processor fabric.” The treatment of these various fabrics may vary from vendor to vendor and from architecture to architecture. In some cases, one or both of the local fabric and the inter-processor fabric may be treated as part of the larger data center fabric 1472. Some FAs have the capability to dynamically handle a physical connection with a plurality of protocols (e.g., either Ethernet or PCIe, depending on the context), in which case PCIe connections to other parts of a rack may usefully be treated as part of fabric 1472. In other embodiments, PCIe is used exclusively within a local node, sled, or sled chassis, in which case it may not be logical to treat the local fabric as part of data center fabric 1472. In yet other embodiments, it is more logically to treat the inter-processor fabric as part of the secure domain of the processor complex, and thus treat it separately from the local fabric and/or data center fabric 1472. In particular, the inter-processor fabric may be cache and/or memory-coherent, meaning that coherent devices can map to the same memory address space, with each treating that address space as its own local address space. Many data center fabrics and local fabrics lack coherency, and so it may be beneficial to treat inter-processor fabric, the local fabric, and the data center fabric as one cohesive fabric, or two or three separate fabrics. Furthermore, the illustration of three levels of fabric in this example should not be construed to exclude more or fewer levels of fabrics, or the mixture of other kinds of fabrics. For example, many data centers use copper interconnects for short communication distances, and fiber optic interconnects for longer distances.

Thus, fabric 1470 may be provided by a single interconnect or a hybrid interconnect, such as where PCIe provides on-chip (for a system-on-a-chip) or on-board communication, 1 Gb or 10 Gb copper Ethernet provides relatively short connections to a ToR switch 1420, and optical cabling provides relatively longer connections to core switch 1430. Interconnect technologies that may be found in the data center include, by way of nonlimiting example, Intel® silicon photonics, an Intel® HFI, a NIC, intelligent NIC (iNIC), smart NIC, an HCA or other host interface, PCI, PCIe, a core-to-core UPI (formerly called QPI or KTI), Infinity Fabric, Intel® Omni-Path™ Architecture (OPA), TrueScale™, FibreChannel, Ethernet, FibreChannel over Ethernet (FCoE), InfiniBand, a legacy interconnect such as a local area network (LAN), a token ring network, a synchronous optical network (SONET), an asynchronous transfer mode (ATM) network, a wireless network such as Wi-Fi or Bluetooth, a “plain old telephone system” (POTS) interconnect or similar, a multi-drop bus, a mesh interconnect, a point-to-point interconnect, a serial interconnect, a parallel bus, a coherent (e.g., cache coherent) bus, a layered protocol architecture, a differential bus, or a Gunning transceiver logic (GTL) bus, to name just a few. The fabric may be cache- and memory-coherent, cache- and memory-non-coherent, or a hybrid of coherent and non-coherent interconnects. Some interconnects are more popular for certain purposes or functions than others, and selecting an appropriate fabric for the instant application is an exercise of ordinary skill. For example, OPA and Infiniband are commonly used in HPC applications, while Ethernet and FibreChannel are more popular in cloud data centers. But these examples are expressly nonlimiting, and as data centers evolve fabric technologies similarly evolve.

Note that while high-end fabrics such as OPA are provided herein by way of illustration, more generally, fabric 1470 may be any suitable interconnect or bus for the particular application. This could, in some cases, include legacy interconnects like LANs, token ring networks, synchronous optical networks (SONET), ATM networks, wireless networks such as Wi-Fi and Bluetooth, POTS interconnects, or similar. It is also expressly anticipated that in the future, new network technologies may arise to supplement or replace some of those listed here, and any such future network topologies and technologies can be or form a part of fabric 1470.

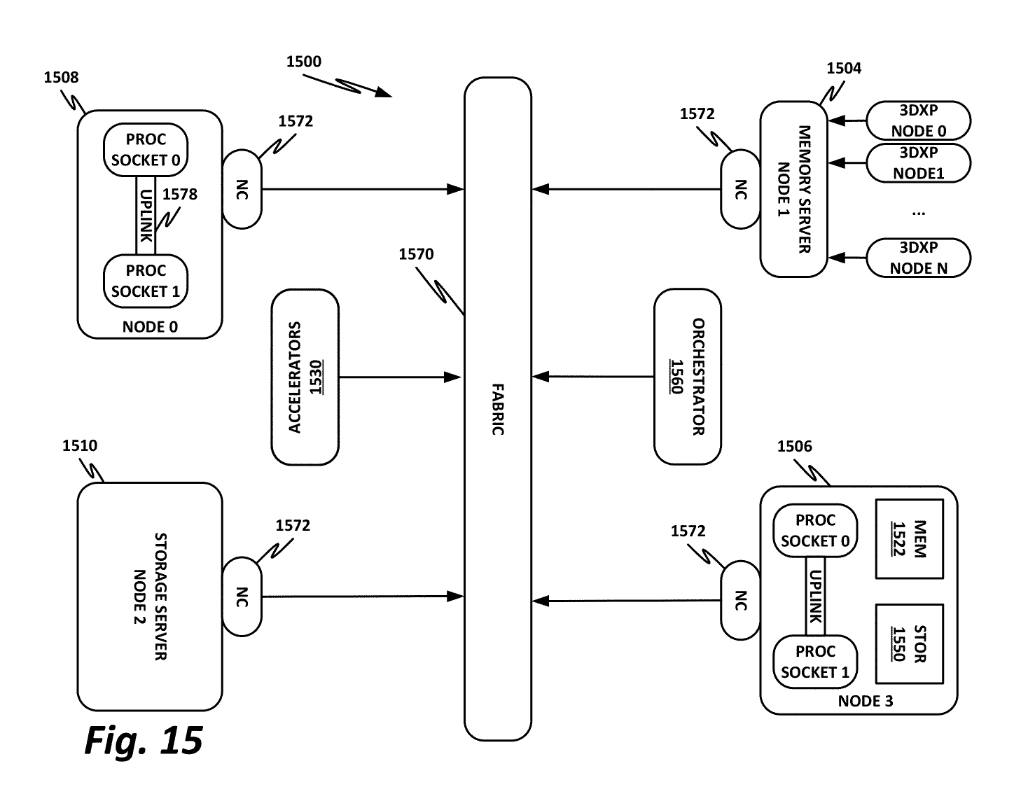

FIG. 15 is a block diagram illustrating selected components of an end-user computing device 1500. Embodiments of computing device 1500 disclosed herein may be adapted or configured to provide a multimode waveguide, according to the teachings of the present specification.

As above, computing device 1500 may provide, as appropriate, cloud service, HPC, telecommunication services, enterprise data center services, or any other compute services that benefit from a computing device 1500.

In this example, a fabric 1570 is provided to interconnect various aspects of computing device 1500. Fabric 1570 may be the same as fabric 1470 of FIG. 14, or may be a different fabric. As above, fabric 1570 may be provided by any suitable interconnect technology. In this example, Intel® Omni-Path™ is used as an illustrative and nonlimiting example.

As illustrated, computing device 1500 includes a number of logic elements forming a plurality of nodes. It should be understood that each node may be provided by a physical server, a group of servers, or other hardware. Each server may be running one or more virtual machines as appropriate to its application.

Node 0 1508 is a processing node including a processor socket 0 and processor socket 1. The processors may be, for example, Intel® Xeon™ processors with a plurality of cores, such as 4 or 8 cores. Node 0 1508 may be configured to provide network or workload functions, such as by hosting a plurality of virtual machines or virtual appliances.

On-board communication between processor socket 0 and processor socket 1 may be provided by an on-board uplink 1578. This may provide a very high-speed, short-length interconnect between the two processor sockets, so that virtual machines running on node 0 1508 can communicate with one another at very high speeds. To facilitate this communication, a virtual switch (vSwitch) may be provisioned on node 0 1508, which may be considered to be part of fabric 1570.

Node 0 1508 connects to fabric 1570 via a network controller (NC) 1572. NC 1572 provides physical interface (a PHY level) and logic to communicatively couple a device to a fabric. For example, NC 1572 may be a NIC to communicatively couple to an Ethernet fabric or an HFI to communicatively couple to a clustering fabric such as an Intel® Omni-Path™, by way of illustrative and nonlimiting example. In some examples, communication with fabric 1570 may be tunneled, such as by providing UPI tunneling over Omni-Path™.

Because computing device 1500 may provide many functions in a distributed fashion that in previous generations were provided on-board, a highly capable NC 1572 may be provided. NC 1572 may operate at speeds of multiple gigabits per second, and in some cases may be tightly coupled with node 0 1508. For example, in some embodiments, the logic for NC 1572 is integrated directly with the processors on a system-on-a-chip (SoC). This provides very high-speed communication between NC 1572 and the processor sockets, without the need for intermediary bus devices, which may introduce additional latency into the fabric. However, this is not to imply that embodiments where NC 1572 is provided over a traditional bus are to be excluded. Rather, it is expressly anticipated that in some examples, NC 1572 may be provided on a bus, such as a PCIe bus, which is a serialized version of PCI that provides higher speeds than traditional PCI. Throughout computing device 1500, various nodes may provide different types of NCs 1572, such as on-board NCs and plug-in NCs. It should also be noted that certain blocks in an SoC may be provided as IP blocks that can be “dropped” into an integrated circuit as a modular unit. Thus, NC 1572 may in some cases be derived from such an IP block.

Note that in “the network is the device” fashion, node 0 1508 may provide limited or no on-board memory or storage. Rather, node 0 1508 may rely primarily on distributed services, such as a memory server and a networked storage server. On-board, node 0 1508 may provide only sufficient memory and storage to bootstrap the device and get it communicating with fabric 1570. This kind of distributed architecture is possible because of the very high speeds of contemporary data centers, and may be advantageous because there is no need to over-provision resources for each node. Rather, a large pool of high-speed or specialized memory may be dynamically provisioned between a number of nodes, so that each node has access to a large pool of resources, but those resources do not sit idle when that particular node does not need them.

In this example, a node 1 memory server 1504 and a node 2 storage server 1510 provide the operational memory and storage capabilities of node 0 1508. For example, memory server node 1 1504 may provide remote direct memory access (RDMA), whereby node 0 1508 may access memory resources on node 1 1504 via fabric 1570 in a direct memory access fashion, similar to how it would access its own on-board memory. The memory provided by memory server 1504 may be traditional memory, such as double data rate type 3 (DDR3) dynamic random access memory (DRAM), which is volatile, or may be a more exotic type of memory, such as a persistent fast memory (PFM) like Intel® 3D Crosspoint™ (3DXP), which operates at DRAM-like speeds, but is non-volatile.

Similarly, rather than providing an on-board hard disk for node 0 1508, a storage server node 2 1510 may be provided. Storage server 1510 may provide a networked bunch of disks (NBOD), PFM, redundant array of independent disks (RAID), redundant array of independent nodes (RAIN), network-attached storage (NAS), optical storage, tape drives, or other non-volatile memory solutions.

Thus, in performing its designated function, node 0 1508 may access memory from memory server 1504 and store results on storage provided by storage server 1510. Each of these devices couples to fabric 1570 via an NC 1572, which provides fast communication that makes these technologies possible.

By way of further illustration, node 3 1506 is also depicted. Node 3 1506 also includes an NC 1572, along with two processor sockets internally connected by an uplink. However, unlike node 0 1508, node 3 1506 includes its own on-board memory 1522 and storage 1550. Thus, node 3 1506 may be configured to perform its functions primarily on-board, and may not be required to rely upon memory server 1504 and storage server 1510. However, in appropriate circumstances, node 3 1506 may supplement its own on-board memory 1522 and storage 1550 with distributed resources similar to node 0 1508.

Computing device 1500 may also include accelerators 1530. These may provide various accelerated functions, including hardware or co-processor acceleration for functions such as packet processing, encryption, decryption, compression, decompression, network security, or other accelerated functions in the data center. In some examples, accelerators 1530 may include deep learning accelerators that may be directly attached to one or more cores in nodes such as node 0 1508 or node 3 1506. Examples of such accelerators can include, by way of nonlimiting example, Intel® QuickData Technology (QDT), Intel® QuickAssist Technology (QAT), Intel® Direct Cache Access (DCA), Intel® Extended Message Signaled Interrupt (MSI-X), Intel® Receive Side Coalescing (RSC), and other acceleration technologies.

In other embodiments, an accelerator could also be provided as an ASIC, FPGA, co-processor, GPU, DSP, or other processing entity, which may optionally be tuned or configured to provide the accelerator function.

The basic building block of the various components disclosed herein may be referred to as “logic elements.” Logic elements may include hardware (including, for example, a software-programmable processor, an ASIC, or an FPGA), external hardware (digital, analog, or mixed-signal), software, reciprocating software, services, drivers, interfaces, components, modules, algorithms, sensors, components, firmware, microcode, programmable logic, or objects that can coordinate to achieve a logical operation. Furthermore, some logic elements are provided by a tangible, non-transitory computer-readable medium having stored thereon executable instructions for instructing a processor to perform a certain task. Such a non-transitory medium could include, for example, a hard disk, solid state memory or disk, read-only memory (ROM), PFM (e.g., Intel® 3D Crosspoint™), external storage, RAID, RAIN, NAS, optical storage, tape drive, backup system, cloud storage, or any combination of the foregoing by way of nonlimiting example. Such a medium could also include instructions programmed into an FPGA, or encoded in hardware on an ASIC or processor.

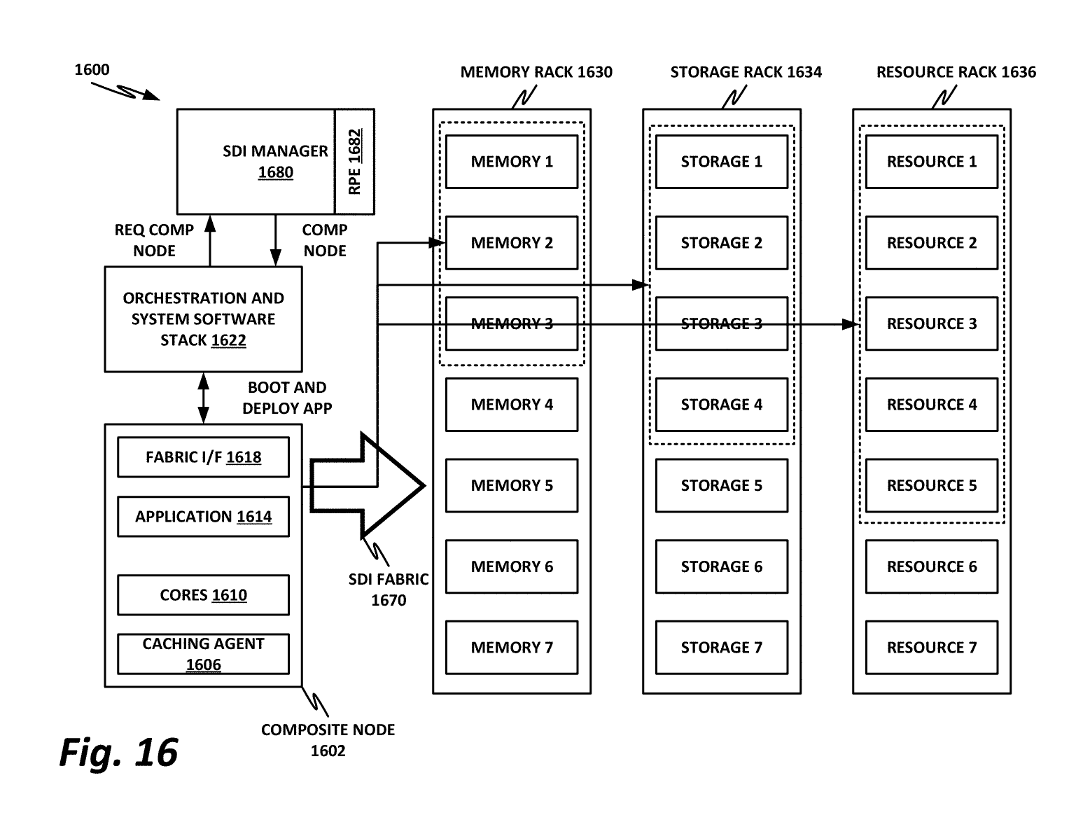

FIG. 16 is a block diagram of a software-defined infrastructure (SDI) data center 1600. Embodiments of SDI data center 1600 disclosed herein may be adapted or configured to provide a multimode waveguide, according to the teachings of the present specification.

Certain applications hosted within SDI data center 1600 may employ a set of resources to achieve their designated purposes, such as processing database queries, serving web pages, or providing computer intelligence.

Certain applications tend to be sensitive to a particular subset of resources. For example, SAP HANA is an in-memory, column-oriented relational database system. A SAP HANA database may use processors, memory, disk, and fabric, while being most sensitive to memory and processors. In one embodiment, composite node 1602 includes one or more cores 1610 that perform the processing function. Node 1602 may also include caching agents 1606 that provide access to high-speed cache. One or more applications 1614 run on node 1602, and communicate with the SDI fabric via FA 1618. Dynamically provisioning resources to node 1602 may include selecting a set of resources and ensuring that the quantities and qualities provided meet required performance indicators, such as service-level agreements (SLAB) and quality of service (QoS). Resource selection and allocation for application 1614 may be performed by a resource manager, which may be implemented within orchestration and system software stack 1622. By way of nonlimiting example, throughout this specification the resource manager may be treated as though it can be implemented separately or by an orchestrator. Note that many different configurations are possible.

In an SDI data center, applications may be executed by a composite node such as node 1602 that is dynamically allocated by SDI manager 1680. Such nodes are referred to as composite nodes because they are not nodes where all of the resources are necessarily collocated. Rather, they may include resources that are distributed in different parts of the data center, dynamically allocated, and virtualized to the specific application 1614.

In this example, memory resources from three memory sleds from memory rack 1630 are allocated to node 1602, storage resources from four storage sleds from storage rack 1634 are allocated, and additional resources from five resource sleds from resource rack 1636 are allocated to application 1614 running on composite node 1602. All of these resources may be associated to a particular compute sled and aggregated to create the composite node. Once the composite node is created, the operating system may be booted in node 1602, and the application may start running using the aggregated resources as if they were physically collocated resources. As described above, FA 1618 may provide certain interfaces that enable this operation to occur seamlessly with respect to node 1602.

As a general proposition, the more memory and compute resources that are added to a database processor, the better throughput it can achieve. However, this is not necessarily true for the disk or fabric. Adding more disk and fabric bandwidth may not necessarily increase the performance of the SAP HANA database beyond a certain threshold.

SDI data center 1600 may address the scaling of resources by mapping an appropriate amount of offboard resources to the application based on application requirements provided by a user or network administrator or directly by the application itself. This may include allocating resources from various resource racks, such as memory rack 1630, storage rack 1634, and resource rack 1636.

In an example, SDI controller 1680 also includes a resource protection engine (RPE) 1682, which is configured to assign permission for various target resources to disaggregated compute resources (DRCs) that are permitted to access them. In this example, the resources are expected to be enforced by an FA servicing the target resource.

In certain embodiments, elements of SDI data center 1600 may be adapted or configured to operate with the disaggregated telemetry model of the present specification.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present specification.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

In the foregoing description, certain aspects of some or all embodiments are described in greater detail than is strictly necessary for practicing the appended claims. These details are provided by way of nonlimiting example only, for the purpose of providing context and illustration of the disclosed embodiments. Such details should not be understood to be required, and should not be “read into” the claims as limitations. The phrase may refer to “an embodiment” or “embodiments.” These phrases, and any other references to embodiments, should be understood broadly to refer to any combination of one or more embodiments. Furthermore, the several features disclosed in a particular “embodiment” could just as well be spread across multiple embodiments. For example, if features 1 and 2 are disclosed in “an embodiment,” embodiment A may have feature 1 but lack feature 2, while embodiment B may have feature 2 but lack feature 1.

This specification may provide illustrations in a block diagram format, wherein certain features are disclosed in separate blocks. These should be understood broadly to disclose how various features interoperate, but are not intended to imply that those features must necessarily be embodied in separate hardware or software. Furthermore, where a single block discloses more than one feature in the same block, those features need not necessarily be embodied in the same hardware and/or software. For example, a computer “memory” could in some circumstances be distributed or mapped between multiple levels of cache or local memory, main memory, battery-backed volatile memory, and various forms of persistent memory such as a hard disk, storage server, optical disk, tape drive, or similar. In certain embodiments, some of the components may be omitted or consolidated. In a general sense, the arrangements depicted in the FIGURES may be more logical in their representations, whereas a physical architecture may include various permutations, combinations, and/or hybrids of these elements. Countless possible design configurations can be used to achieve the operational objectives outlined herein. Accordingly, the associated infrastructure has a myriad of substitute arrangements, design choices, device possibilities, hardware configurations, software implementations, and equipment options.

References may be made herein to a computer-readable medium, which may be a tangible and non-transitory computer-readable medium. As used in this specification and throughout the claims, a “computer-readable medium” should be understood to include one or more computer-readable mediums of the same or different types. A computer-readable medium may include, by way of nonlimiting example, an optical drive (e.g., CD/DVD/Blu-Ray), a hard drive, a solid state drive, a flash memory, or other non-volatile medium. A computer-readable medium could also include a medium such as a ROM, an FPGA, or an ASIC configured to carry out the desired instructions, stored instructions for programming an FPGA or ASIC to carry out the desired instructions, an intellectual property (IP) block that can be integrated in hardware into other circuits, or instructions encoded directly into hardware or microcode on a processor such as a microprocessor, DSP, microcontroller, or in any other suitable component, device, element, or object where appropriate and based on particular needs. A non-transitory storage medium herein is expressly intended to include any non-transitory special-purpose or programmable hardware configured to provide the disclosed operations, or to cause a processor to perform the disclosed operations.

Various elements may be “communicatively,” “electrically,” “mechanically,” or otherwise “coupled” to one another throughout this specification and the claims. Such coupling may be a direct, point-to-point coupling, or may include intermediary devices. For example, two devices may be communicatively coupled to one another via a controller that facilitates the communication. Devices may be electrically coupled to one another via intermediary devices such as signal boosters, voltage dividers, or buffers. Mechanically coupled devices may be indirectly mechanically coupled.

Any “module” or “engine” disclosed herein may refer to or include software, a software stack, a combination of hardware, firmware, and/or software, a circuit configured to carry out the function of the engine or module, or any computer-readable medium as disclosed above. Such modules or engines may, in appropriate circumstances, be provided on or in conjunction with a hardware platform, which may include hardware compute resources such as a processor, memory, storage, interconnects, networks and network interfaces, accelerators, or other suitable hardware. Such a hardware platform may be provided as a single monolithic device (e.g., in a PC form factor), or with some or part of the function being distributed (e.g., a “composite node” in a high-end data center, where compute, memory, storage, and other resources may be dynamically allocated and need not be local to one another).

There may be disclosed herein flow charts, signal flow diagram, or other illustrations showing operations being performed in a particular order. Unless otherwise expressly noted, or unless required in a particular context, the order should be understood to be a nonlimiting example only. Furthermore, in cases where one operation is shown to follow another, other intervening operations may also occur, which may be related or unrelated. Some operations may also be performed simultaneously or in parallel. In cases where an operation is said to be “based on” or “according to” another item or operation, this should be understood to imply that the operation is based at least partly on or according at least partly to the other item or operation. This should not be construed to imply that the operation is based solely or exclusively on, or solely or exclusively according to the item or operation.

All or part of any hardware element disclosed herein may readily be provided in an SoC, including a central processing unit (CPU) package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package.

In a general sense, any suitably-configured circuit or processor can execute any type of instructions associated with the data to achieve the operations detailed herein. Any processor disclosed herein could transform an element or an article (for example, data) from one state or thing to another state or thing. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, should be construed as being encompassed within the broad terms “memory” and “storage,” as appropriate.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. Any suitable processor and memory can be suitably coupled to the board based on particular configuration needs, processing demands, and computing designs. Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### EXAMPLE IMPLEMENTATIONS

The following examples are provided by way of illustration.

Example 1 includes a communication apparatus, comprising: a local data interface; a data encoder to encode a transmission into n millimeter to terahertz-band transmission components, wherein n>2, each transmission component having an independent mode of each other transmission component; and a plurality of n launchers to launch the transmission components onto n closely-bundled waveguides, wherein the closely-bundled waveguides are not shielded from one another.

Example 2 includes the communication apparatus of example 1, wherein n=4.

Example 3 includes the communication apparatus of example 1, wherein the independent modes are linearly independent.

Example 4 includes the communication apparatus of example 1, wherein the independent modes are orthogonal or nearly orthogonal.

Example 5 includes the communication apparatus of example 1, wherein the data encoder comprises a matrix multiplier.

Example 6 includes the communication apparatus of example 5, wherein the matrix multiplier is a passive matrix multiplier.

Example 7 includes the communication apparatus of example 6, wherein the passive matrix multiplier is a 180-degree hybrid junction.

Example 8 includes the communication apparatus of example 5, wherein the matrix multiplier comprises active circuitry.

Example 9 includes the communication apparatus of example 1, further comprising a receiver having a data decoder to decode an incoming transmission on the n closely-bundled waveguides.

Example 10 includes the communication apparatus of example 9, wherein the data decoder comprises an inverse matrix multiplier.

Example 11 includes the communication apparatus of example 9, wherein the inverse matrix multiplier is passive.

Example 12 includes the communication apparatus of example 11, wherein the inverse matrix multiplier comprises a 180-degree hybrid junction.

Example 13 includes the communication apparatus of example 9, wherein inverse matrix multiplier is active.

Example 14 includes the communication apparatus of any of examples 1-13, wherein the local data interface is a peripheral component interconnect express (PCIe) interconnect.

Example 15 includes a multimode waveguide, comprising: an outer conductive shield; a dielectric cladding disposed within the outer conductive shield; and a plurality of n closely-bundled core dielectric waveguides disposed within the dielectric cladding with no conductive shielding between the core dielectric waveguides.

Example 16 includes the multimode waveguide of example 15, wherein n=4.

Example 17 includes the multimode waveguide of example 15, wherein the core dielectric waveguides are of substantially identical material.

Example 18 includes the multimode waveguide of example 15, wherein the core dielectric waveguides are of substantially identical construction.

Example 19 includes the multimode waveguide of example 15, wherein the core dielectric waveguides have a substantially higher relative permittivity than the dielectric cladding.

Example 20 includes the multimode waveguide of example 15, wherein the core dielectric waveguides are configured to guide a transmission frequency of approximately 300 GHz to 1 THz.

Example 21 includes the multimode waveguide of example 15, wherein the core dielectric waveguides are rectangular and have cross-sectional dimensions of approximately 200 μm×400 μm.

Example 22 includes the multimode waveguide of example 15, wherein the core dielectric waveguides are rectangular and have cross-sectional dimensions of approximately 100 μm×400 μm.

Example 23 includes the multimode waveguide of example 15, wherein the core dielectric waveguides have a relative permittivity of approximately 3 to 20.

Example 24 includes the multimode waveguide of example 15, wherein the dielectric cladding has a relative permittivity of approximately 1.5 to 3.

Example 25 includes a server rack, comprising: a first server having a first launcher assembly, the first launcher assembly comprising: a transmitter configured to encode n millimeter to terahertz-band transmissions having independent modes of each other; and n spatially-close launchers to launch the transmissions; a multimode wave guide communicatively coupled to the first launcher assembly, the waveguide comprising n closely-bundled core waveguides communicatively coupled to the n launchers, and a dielectric cladding disposed between the core waveguide without intermediate shielding; and a second server having a second launcher assembly, the second launcher assembly comprising a receiver configured to decode the transmissions.

Example 26 includes the server rack of example 25, wherein n=4.

Example 27 includes the server rack of example 25, wherein the independent modes are linearly independent.

Example 28 includes the server rack of example 25, wherein the independent modes are orthogonal or nearly orthogonal.

Example 29 includes the server rack of example 25, wherein the data encoder comprises a matrix multiplier.

Example 30 includes the server rack of example 29, wherein the matrix multiplier is a passive matrix multiplier.

Example 31 includes the server rack of example 30, wherein the passive matrix multiplier is a 180-degree hybrid junction.

Example 32 includes the server rack of example 29, wherein the matrix multiplier comprises active circuitry.

Example 33 includes the server rack of example 25, wherein the decoder comprises an inverse matrix multiplier.

Example 34 includes the server rack of example 33, wherein the inverse matrix multiplier is passive.

Example 35 includes the server rack of example 34, wherein the inverse matrix multiplier comprises a 180-degree hybrid junction.

Example 36 includes the server rack of example 34, wherein inverse matrix multiplier is active.

Example 37 includes the server rack of example 25, wherein the core dielectric waveguides are of substantially identical material.

Example 38 includes the server rack of example 25, wherein the core dielectric waveguides are of substantially identical construction.

Example 39 includes the server rack of example 25, wherein the core dielectric waveguides have a substantially higher relative permittivity than the dielectric cladding.

Example 40 includes the server rack of example 25, wherein the core dielectric waveguides are configured to guide a transmission frequency of approximately 300 GHz to 1 THz.

Example 41 includes the server rack of example 25, wherein the core dielectric waveguides are rectangular and have cross-sectional dimensions of approximately 200 μm×400 μm.

Example 42 includes the server rack of example 25, wherein the core dielectric waveguides are rectangular and have cross-sectional dimensions of approximately 100 μm×400 μm.

Example 43 includes the server rack of example 25, wherein the core dielectric waveguides have a relative permittivity of approximately 3 to 20.

Example 44 includes the server rack of example 25, wherein the dielectric cladding has a relative permittivity of approximately 1.5 to 3.

What is claimed is:

1. A communication apparatus, comprising:
a local data interface;
a data encoder to encode a transmission into n millimeter to terahertz-band transmission components, wherein n≥2, each transmission component having an independent mode of each other transmission component; and
a plurality of n launchers to launch the transmission components onto n closely-bundled waveguides, wherein the closely-bundled waveguides are not shielded from one another.

2. The communication apparatus of claim 1, wherein n=4.

3. The communication apparatus of claim 1, wherein the independent modes are linearly independent.

4. The communication apparatus of claim 1, wherein the independent modes are orthogonal or nearly orthogonal.

5. The communication apparatus of claim 1, wherein the data encoder comprises a matrix multiplier.

6. The communication apparatus of claim 5, wherein the matrix multiplier is a passive matrix multiplier.

7. The communication apparatus of claim 6, wherein the passive matrix multiplier is a 180-degree hybrid junction.

8. The communication apparatus of claim 5, wherein the matrix multiplier comprises active circuitry.

9. The communication apparatus of claim 1, further comprising a receiver having a data decoder to decode an incoming transmission on the n closely-bundled waveguides.

10. The communication apparatus of claim 9, wherein the data decoder comprises an inverse matrix multiplier.

11. The communication apparatus of claim 9, wherein the inverse matrix multiplier is passive.

12. The communication apparatus of claim 11, wherein the inverse matrix multiplier comprises a 180-degree hybrid junction.

13. The communication apparatus of claim 9, wherein inverse matrix multiplier is active.

14. A multimode waveguide, comprising:
an outer conductive shield;
a dielectric cladding disposed within the outer conductive shield; and
a plurality of n closely-bundled core dielectric waveguides disposed within the dielectric cladding with no conductive shielding between the core dielectric waveguides.

15. The multimode waveguide of claim 14, wherein n=4.

16. The multimode waveguide of claim 14, wherein the core dielectric waveguides are of substantially identical material.

17. The multimode waveguide of claim 14, wherein the core dielectric waveguides are of substantially identical construction.

18. The multimode waveguide of claim 14, wherein the core dielectric waveguides have a substantially higher relative permittivity than the dielectric cladding.

19. The multimode waveguide of claim 14, wherein the core dielectric waveguides are configured to guide a transmission frequency of approximately 300 GHz to 1 THz.

20. The multimode waveguide of claim 14, wherein the core dielectric waveguides are rectangular and have cross-sectional dimensions of approximately 200 μm×400 μm.

21. The multimode waveguide of claim 14, wherein the core dielectric waveguides are rectangular and have cross-sectional dimensions of approximately 100 μm×400 μm.

22. The multimode waveguide of claim 14, wherein the core dielectric waveguides have a relative permittivity of approximately 3 to 20.

23. The multimode waveguide of claim 14, wherein the dielectric cladding has a relative permittivity of approximately 1.5 to 3.

24. A server rack, comprising:
a first server having a first launcher assembly, the first launcher assembly comprising:
a transmitter configured to encode n millimeter to terahertz-band transmissions having independent modes of each other; and
n spatially-close launchers to launch the transmissions;
a multimode wave guide communicatively coupled to the first launcher assembly, the waveguide comprising n closely-bundled core waveguides communicatively coupled to the n launchers, and a dielectric cladding disposed between the core waveguides without intermediate shielding; and
a second server having a second launcher assembly, the second launcher assembly comprising a receiver configured to decode the transmissions.

25. The server rack of claim 24, wherein n=4.
